(19) United States
(12) Patent Application Publication
(10) Pub. No.: US 2020/0288204 A1
(43) Pub. Date: Sep. 10, 2020

(54) GENERATING AND PROVIDING PERSONALIZED DIGITAL CONTENT IN REAL TIME BASED ON LIVE USER CONTEXT

(71) Applicant: Adobe Inc., San Jose, CA (US)

(72) Inventors: Brian Duersch, Mountain View, CA (US); Kristopher Paries, American Fork, UT (US)

(21) Appl. No.: 16/293,076

(22) Filed: Mar. 5, 2019

(51) Int. Cl. H04N 21/466; H04N 21/45; G06N 20/00; G06F 16/9535; G06K 9/00

(52) U.S. Cl. CPC H04N 21/4666; H04N 21/4532; G06K 9/00228; G06F 16/9535; G06N 20/00

(57) ABSTRACT

The present disclosure relates to generating personalized digital content in real time based on a live user context. For example, the disclosed systems can collect a stream of digital media comprising a digital video portraying a user while the user accesses one or more websites via a client device. The disclosed systems can then analyze the digital video to identify characteristics of the user portrayed in the digital video and/or to identify objects portrayed in the digital video. The disclosed systems can then utilize a context-based machine learning model to select digital content to provide to the user based on the identified characteristics and/or objects. While the user accesses the one or more websites, the disclosed systems can modify the one or more websites to include the selected subset of digital content and provide the modified one or more websites for display via the client device.

### BACKGROUND

Recent years have seen significant improvements in hardware and software platforms for generating personalized digital content. For example, digital content personalization systems can identify digital content that is relevant to a user (e.g., relevant to the user's needs, interests, age, occupation, location, etc.) and provide the digital content to a client device associated with the user. In particular, some digital content personalization systems can identify a user context by collecting data that characterizes the corresponding user. The digital content personalization systems can then determine which digital content is relevant to the user based on the user context.

Despite these advances, however, conventional digital content personalization systems suffer from several technological shortcomings that lead to inflexible and inaccurate operation. For example, conventional digital content personalization systems are often inflexible in that they rigidly identify digital content relevant to users based on old, outdated data. In particular, many conventional systems identify a user context using data that has been stored prior to the time the user context is used to identify the relevant digital content for the corresponding user. For example, the conventional systems may utilize data corresponding to the user's browsing history (e.g., a cookie associated with a visit to a website) or data previously submitted by the user as part of an online user profile. By relying on old data, such conventional systems often fail to flexibly accommodate changes to the user context.

In addition to flexibility concerns, conventional digital content personalization systems are also inaccurate. In particular, because conventional digital content personalization systems identify user contexts using old data, such systems are often unaware of a user's current context (i.e., the user's current needs, interests, etc.). Consequently, these conventional systems inaccurately identify digital content that is currently relevant to the user.

These, along with additional problems and issues, exist with regard to conventional digital content personalization systems.

### SUMMARY

One or more embodiments described herein provide benefits and/or solve one or more of the foregoing or other problems in the art with systems, methods, and non-transitory computer readable storage media that generate hyper-personalized digital content accurately based on a live (i.e., current) user context utilizing machine learning models. In particular, the disclosed systems can process live data signals utilizing an object recognition neural network classifier, an attention controlled neural network facial detection model, and/or an audio detection machine learning model to identify a live user context. For example, the disclosed systems can process a live video feed to identify current features (e.g., age, gender, and emotion etc.) of a user portrayed in the video. Additionally, the disclosed systems can identify objects portrayed in the video. The disclosed systems can further process live audio to identify words spoken by the user and additional features, such as tone of voice. Subsequently, the disclosed systems can utilize a context-based digital content machine learning model (e.g., a neural network) to dynamically change, in real time, the content of a website accessed by the user based on the identified user context. By utilizing various machine learning models to process live data and provide personalized digital content for users in real time, the disclosed systems can flexibly and accurately provide digital content that is currently relevant to users.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a digital content personalization system can operate in accordance with one or more embodiments;

FIG. 2 illustrates a block diagram of a digital content personalization system generating personalized digital content in accordance with one or more embodiments;

FIG. 3 illustrates a website template used for displaying personalized digital content via a client device in accordance with one or more embodiments;

FIG. 4A illustrates a block diagram for analyzing a digital video to generate personalized digital content in accordance with one or more embodiments;

FIG. 4B illustrates a block diagram for training a facial detection model comprising an attention controlled neural network using image triplets and a triplet-loss function;

FIG. 4C illustrates a block diagram for training an object detection model comprising a convolutional neural network to detect and classify objects in accordance with one or more embodiments;

FIG. 4D illustrates a block diagram for training a context-based digital content machine learning model comprising a reinforcement learning model in accordance with one or more embodiments;

FIG. 4E illustrates a block diagram for training a context-based digital content machine learning model comprising a neural network to generate personalized digital content in accordance with one or more embodiments;

FIG. 4F illustrates a block diagram of a context-based digital content machine learning model that utilizes scene compatibility to generate personalized digital content;

FIG. 5 illustrates a block diagram for utilizing a gaze of a user to generate personalized digital content in accordance with one or more embodiments;

FIG. 6 illustrates a block diagram for analyzing audio content to generate personalized digital content in accordance with one or more embodiments;

FIG. 7 illustrates a user interface through which the digital content personalization system can provide a digital characteristics report in accordance with one or more embodiments;

FIGS. 8A-8C illustrate block diagrams of the digital content personalization system dynamically changing personalized digital content based on a changing live user context in accordance with one or more embodiments;

FIG. 9 illustrates an example schematic diagram of a digital content personalization system in accordance with one or more embodiments;

FIG. 10 illustrates a flowchart of a series of acts for generating personalized digital content in accordance with one or more embodiments; and

FIG. 11 illustrates a block diagram of an exemplary computing device in accordance with one or more embodiments.

### DETAILED DESCRIPTION

One or more embodiments described herein include a digital content personalization system that utilizes machine learning to generate and provide personalized digital content in real time that is accurately relevant to a live user context. In particular, the digital content personalization system can utilize machine learning technology to process live data signals, breaking down the included data into components that are then used to flexibly personalize digital content for changing interests and needs. For example, the digital content personalization system can utilize an object recognition neural network classifier and an attention controlled neural network facial detection model to process a live video feed to identify current features (e.g., age, gender, and emotion etc.) of a user portrayed in the video as well as objects portrayed in the video. In one or more embodiments, the digital content personalization system can further process live audio using an audio detection machine learning model to identify words spoken by the user as well as additional current features of the user, such as tone of voice. Subsequently, the digital content personalization system can utilize a context-based digital content machine learning model (e.g., a neural network) to change, in real time, the digital content of a website accessed by the user based on the identified user context.

To provide an example, in one or more embodiments, the digital content personalization system collects a stream of digital media comprising a digital video that portrays a user while the user accesses one or more websites via a client device. The digital content personalization system can then utilize a facial detection model and an object detection model to identify characteristics of the user by analyzing the digital video. Subsequently, the digital content personalization system can utilize a context-based digital content machine learning model to select a subset of digital content from a repository of digital content based on the identified characteristics of the user. After selecting the subset of digital content, and while the user is accessing the one or more websites, the digital content personalization system can modify the one or more websites to include the selected subset of digital content and provide the modified one or more websites for display via the client device. In one or more embodiments, the digital content personalization system further identifies an object portrayed in the digital video and selects the subset of digital content further based on the identified object.

As just mentioned, in one or more embodiments, the digital content personalization system identifies characteristics of a user by analyzing a digital video—from a collected stream of digital media—that portrays the user while the user accesses one or more websites via a client device. In particular, the digital content personalization system can analyze the digital video using a facial detection model to identify the facial characteristics of the user. Such characteristics can include, but are not limited to, an emotion of the user, a gender of the user, an age of the user, apparel of the user (e.g., whether the user is wearing glasses or a hat), or a gaze of the user (i.e., via head tracking or eye tracking). In one or more embodiments, the facial detection model comprises a machine learning model. As outlined in greater detail below, the digital content personalization system can utilize an attention controlled neural network and/or subsegment-based methods for facial attribute detection to identify facial characteristics.

Additionally, as mentioned above, in one or more embodiments, the digital content personalization system can additionally analyze the digital video of the user to identify an object portrayed in the digital video. In particular, the digital content personalization system can analyze the digital video using an object detection model to identify the portrayed object. In one or more embodiments, the object detection model comprises a machine learning model. For example, the object detection model can comprise a neural network, such as a neural network classifier trained to identify objects from an image or video. In one or more embodiments, the digital content personalization system utilizes a convolutional neural network that utilizes k-means clustering on training digital images to accurately identify objects portrayed in a digital video.

In some embodiments, the digital media further includes audio content that provides audio portraying the user while the user accesses the one or more websites. For example, the audio content can include words spoken or noises made by the user or any other background noises. The digital content personalization system can analyze the audio content, while the user is accessing the one or more websites, to identify additional characteristics of the user. For example, the digital content personalization system can determine the language of the user's speech as well as the tone of the user's voice to determine an understanding of the user's meaning. In one or more embodiments, the digital content personalization system analyzes the audio content using an audio detection model, which can include a machine learning model.

Further, as mentioned above, in one or more embodiments, the digital content personalization system utilizes a context-based digital content machine learning model to select a subset of digital content from a repository of digital content based on the identified characteristics of the user. More specifically, the context-based digital content machine learning model selects the subset of digital content based on a live user context. In one or more embodiments, the digital content personalization system identifies the live user context by analyzing the digital video portraying the user using the facial detection model to identify characteristics of the user. In some embodiments, the live user context further includes one or more objects identified by analyzing the digital video using the object detection model. In further embodiments, the user context includes additional characteristics of the user identified by analyzing audio content portraying the user using an audio detection model.

For example, in one or more embodiments, the digital content personalization system utilizes a context-based digital content machine learning model that comprises a neural network trained to determine user result (e.g., response at a client device) based on user context and different digital content items. The digital content personalization system can analyze different digital content options using the trained neural network and select the digital content with the most desirable predicted user result. In one or more embodiments, the context-based digital content machine learning model includes a reinforcement learning model that utilizes a policy gradient to modify a digital content selection policy based on observed rewards. In some embodiments, the context context-based digital content machine learning model selects digital content based on scene compatibility with the characteristics or items portrayed in the digital image.

In one or more embodiments, after selecting the subset of digital content, the digital content personalization system modifies the one or more websites to include the subset of digital content in real time (i.e., while the user is accessing the one or more websites). As the digital content personalization system continues to collect and analyze digital media—including the digital video and/or audio content, the digital content personalization system can continue to modify the one or more websites accessed by the user with digital content selected based on updates to the user context.

The digital content personalization system provides several advantages over conventional systems. For example, the digital content personalization system improves flexibility. In particular, by identifying user contexts using live data (e.g., the user characteristics and/or identified objects) obtained from streams of digital media (including digital video and/or audio content), the digital content personalization system can identify the current interests and needs of users. Consequently, the digital content personalization system can provide digital content that flexibly accommodates changes to those interests or needs.

Additionally, the digital content personalization system improves accuracy. In particular, because the digital content personalization system can identify a live user context associated with a user, the digital content personalization system can identify the current interests and needs of the user. Accordingly, the digital content personalization system can accurately select digital content that satisfies those current interests and needs.

As illustrated by the foregoing discussion, the present disclosure utilizes a variety of terms to describe features and benefits of the digital content personalization system. Additional detail is now provided regarding the meaning of these terms. For example, as used herein, the term “digital content” refers to digital data. In particular, digital content refers to any digital text, image, video, or combination thereof. As an example, digital content can include content or data presented on a website or computer application via a client device.

Additionally, as used herein, the term “user context” or “context” refers to information regarding a user and/or the circumstances of the user. For example, a user context can include information related to characteristics of the user or information related to objects associated with the user. Relatedly, a “live user context” refers to user context determined in real-time (e.g., while a user interacts with a web site). For example, by continuously updating a user context in real time as the characterization of a user changes, the digital content personalization system defines (i.e., identifies) a live user context.

Further, as used herein, the term “digital media” refers to a digital image, digital video, and/or digital audio. Relatedly, as used herein, the term “stream of digital media” refers to a live feed of digital media. In particular, a stream of digital media refers to digital media that is communicated from a device that generates the digital media to another device as the digital media is generated (or without significant delay). For example, a stream of digital media can include a live feed of digital video or a live feed of audio content.

Additionally, as used herein, the term “digital content element” refers to a component, slot, and/or region for providing digital content. In particular, a digital content element refers to a component, slot, and/or region of a user interface (e.g., a website user interface) for displaying digital content on a client device. For example, a digital content element can include a component for displaying a title, a header, text (e.g., one or more sentences, paragraphs, columns, etc.), an image, a video, a caption, a link, or an action button within a website (or other user interface).

As used herein, the term “characteristic” or “characteristic of a user” refers to a trait of a user. In particular, a characteristic of a user can refer to a quality—physical, mental, emotional, etc.—that can be attributed to a user. For example, a characteristic of a user can include an emotion of the user, a gender of the user, an age of the user, apparel of the user, a gaze of the user, or a tone of voice of the user. Relatedly, the term “facial characteristic” or “facial characteristic of a user” refers to a characteristic identified by analyzing the face or a representation of the face of the user. In particular, facial characteristics can refer to those characteristics identifiable by analyzing the physical features of the face, movement of the face, or the expression portrayed on the user's face. For example, facial characteristics can specifically include an emotion of the user, a gender of the user, an age of the user, apparel of the user, or a gaze of the user as determined by analyzing the user's face.

Additionally, used herein, the term “facial detection model” refers to a computer algorithm or model that identifies characteristics of a user. In particular, a facial detection model includes a computer algorithm that can analyze a face or a representation of a face (e.g., a digital image or digital video) and identify one or more facial characteristics based on the analysis. For example, the facial detection model can refer to a machine learning model. More detail regarding the facial detection model will be provided below.

As used herein, the term “object detection model” refers to a computer algorithm or model that identifies objects. In particular, an object detection model includes a computer algorithm that analyzes a digital image and/or digital video and identifies one or more objects portrayed therein. For example, the object detection model can include a machine learning model. More specifically, in one or more embodiments, the object detection model includes a neural network, such as a neural network classifier. More detail regarding the object detection model will be provided below.

Further, as used herein, the term “audio detection model” refers to a computer algorithm or model that identifies sounds portrayed in audio content. In particular, an audio detection model includes a computer algorithm that analyzes audio content and identifies one or more sounds and any associated characteristics. For example, the audio detection model can identify the speech of a user—including the spoken words themselves—as well as any characteristics associated with that speech (e.g., tone of voice or emotion of the user). Further, the audio detection model can identify any other sounds provided by the user or some other source (e.g., background noise, sounds provided by objects or animals close to the user, sounds of movement or action provided by the user, etc.). In one or more embodiments, the audio detection model refers to a machine learning model. More detail regarding the audio detection model will be provided below.

Additionally, as used herein, the term “context-based digital content machine learning model” refers to a computer algorithm or model trained to select digital content that is relevant to a user. In particular, a context-based digital content machine learning model includes a computer algorithm that utilizes a user context (e.g., identified user characteristics and/or identified objects) to select a subset of digital content that is relevant to the corresponding user. For example, the context-based digital content machine learning model can refer to a machine learning model, such as a neural network. More detail regarding the context-based digital content machine learning model will be provided below.

As used herein, a “machine learning model” refers to a computer representation that can be tuned (e.g., trained) based on inputs to approximate unknown functions. In particular, the term “machine-learning model” can include a model that utilizes algorithms to learn from, and make predictions on, known data by analyzing the known data to learn to generate outputs that reflect patterns and attributes of the known data. For instance, a machine-learning model can include but is not limited to a neural network (e.g., a convolutional neural network, recurrent neural network or other deep learning network), a decision tree (e.g., a gradient boosted decision tree), association rule learning, inductive logic programming, support vector learning, Bayesian network, regression-based model (e.g., censored regression), principal component analysis, or a combination thereof.

As mentioned, a machine learning model can include a neural network. As used herein, the term “neural network” refers to a machine learning model that includes a model of interconnected artificial neurons (organized in layers) that communicate and learn to approximate complex functions and generate outputs based on a plurality of inputs provided to the model. In addition, a neural network is an algorithm (or set of algorithms) that implements deep learning techniques that utilize a set of algorithms to model high-level abstractions in data.

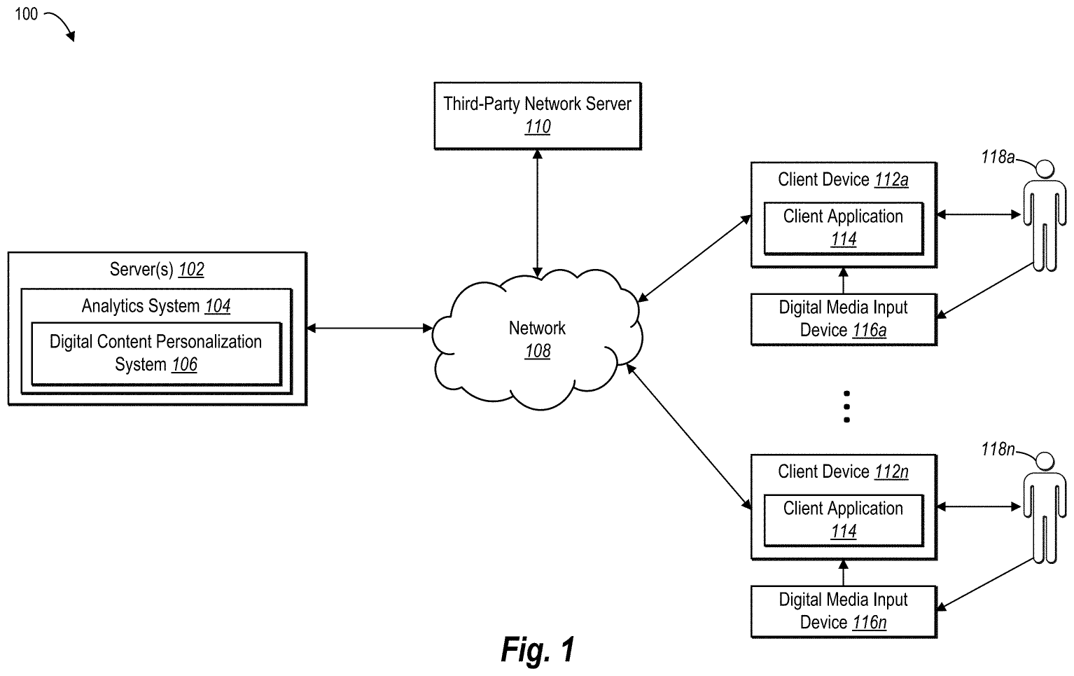

Additional detail regarding the digital content personalization system will now be provided with reference to the figures. It should be noted that the digital content personalization system will be discussed in the context of generating personalized digital content for one or more websites accessed by a user; however, application of the digital content personalization system is not so limited. For example, the principles and features of the digital content personalization system discussed herein are equally applicable and effective in other implementations, such as an implementation in conjunction with an in-store retail experience (e.g., a retail kiosk) or any software application (e.g., mobile applications). Turning now to the figures, FIG. 1 illustrates a schematic diagram of an exemplary system environment (“environment”) 100 in which a digital content personalization system 106 can be implemented. As illustrated in FIG. 1, the environment 100 can include a server(s) 102, a network 108, a third-party network server 110, client devices 112a-112n, digital media input devices 116a-116n, and users 118a-118n.

Although the environment 100 of FIG. 1 is depicted as having a particular number of components, the environment 100 can have any number of additional or alternative components (e.g., any number of servers, third-party network servers, client devices, digital media input devices, or other components in communication with the digital content personalization system 106 via the network 108). Similarly, although FIG. 1 illustrates a particular arrangement of the server(s) 102, the network 108, the third-party network server 110, the client devices 112a-112n, the digital media input devices 116a-116n, and the users 118a-118n, various additional arrangements are possible.

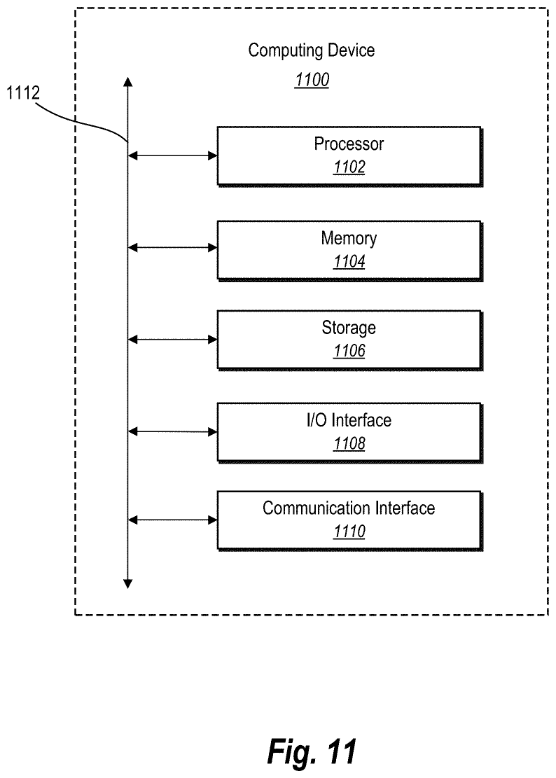

The server(s) 102, the network 108, the third-party network server 110, the client devices 112a-112n, and the digital media input devices 116a-116n may be communicatively coupled with each other either directly or indirectly (e.g., through the network 108 discussed in greater detail below in relation to FIG. 11). Moreover, the server(s) 102, the third-party network server 110, and the client devices 112a-112n may include a computing device (including one or more computing devices as discussed in greater detail below with relation to FIG. 11).

As mentioned above, the environment 100 includes the server(s) 102. The server(s) 102 can generate, store, receive, and/or transmit data, including personalized digital content. For example, the server(s) 102 can receive a stream of digital media portraying the user 118a from the digital media input device 116a (e.g., via the client device 112a) and transmit personalized digital content to the third-party network server 110 for display via the client device 112a. In one or more embodiments, the server(s) 102 comprises a data server. The server(s) 102 can also comprise a communication server or a web-hosting server.

As shown in FIG. 1, the server(s) 102 can include an analytics system 104. In particular, the analytics system 104 can collect, manage, and utilize analytics data. For example, the analytics system 104 can collect analytics data related to user contexts, the digital content selected based on those user contexts, and the rewards resulting from providing the digital content for display to a user. The analytics system 104 can collect the analytics data in a variety of ways. For example, in one or more embodiments, the analytics system 104 causes the server(s) 102 and/or the third-party network server 110 to collect user context data and report the collected user context data for storage on a database. In one or more embodiments, the analytics system 104 receives the user context data directly from the client devices 112a-112n via data stored thereon.

Additionally, the server(s) 102 include the digital content personalization system 106. In particular, in one or more embodiments, the digital content personalization system 106 uses the server(s) 102 to select and provide digital content based on a user context. For example, the digital content personalization system 106 can use the server(s) 102 to identify characteristics of a user and select digital content to provide for display to the user based on the identified characteristics.

For example, in one or more embodiments, the server(s) 102 can collect a stream of digital media comprising a digital video portraying a user while the user accesses one or more websites via a client device. The server(s) 102 can then analyze the digital video to identify one or more characteristics of the user. Utilizing a context-based digital content machine learning model, the server(s) 102 can select a subset of digital content from a repository of digital content based on the identified characteristics. While the user is still accessing the one or more websites, the server(s) 102 can modify the one or more websites to include the subset of digital content and provide the modified one or more websites for display via the client device.

As shown in FIG. 1, the environment 100 also includes the third-party network server 110. In one or more embodiments, the third-party network server 110 provides access to third-party digital content to the client devices 112a-112n. For example, the third-party network server 110 can host and provide access to one or more websites created and/or managed by a third party. In some embodiments, the third-party network server 110 hosts digital content accessible through an application (e.g., the client application 114, such as a social networking application) hosted on the client devices 112a-112n. The server(s) 102 can provide digital content (e.g., personalized digital content) directly to the client devices 112a-112n or provide digital content to the client devices 112a-112n via the third-party network server 110.

In one or more embodiments, the client devices 112a-112n include computer devices that allow users of the devices (e.g., the users 118a-118n) to access digital content provided by the third-party network server 110. For example, the client devices 112a-112n can include smartphones, tablets, desktop computers, laptop computers, or other electronic devices. The client devices 112a-112n can include one or more applications (e.g., the client application 114) that allow the users 118a-118n to access the service provided by the third-party network server 110. For example, the client application 114 can include a software application installed on the client devices 112a-112n. Additionally, or alternatively, the client application 114 can include a software application hosted on the third-party network server 110, which may be accessed by the client devices 112a-112n through another application, such as a web browser.

As shown in FIG. 1, the environment 100 further includes the digital media input devices 116a-116n. In one or more embodiments, the digital media input devices 116a-116n include any device that can generate a stream of digital media. For example, the digital media input devices 116a-116n can include a video camera for generating a digital video and/or a microphone for generating audio content. Though FIG. 1 shows the digital media input devices 116a-116n as separate from the client devices 112a-112n, in some embodiments, the digital media input devices 116a-116n are integrated directly into the client devices 112a-112n (e.g., a camera integrated into a laptop or smartphone).

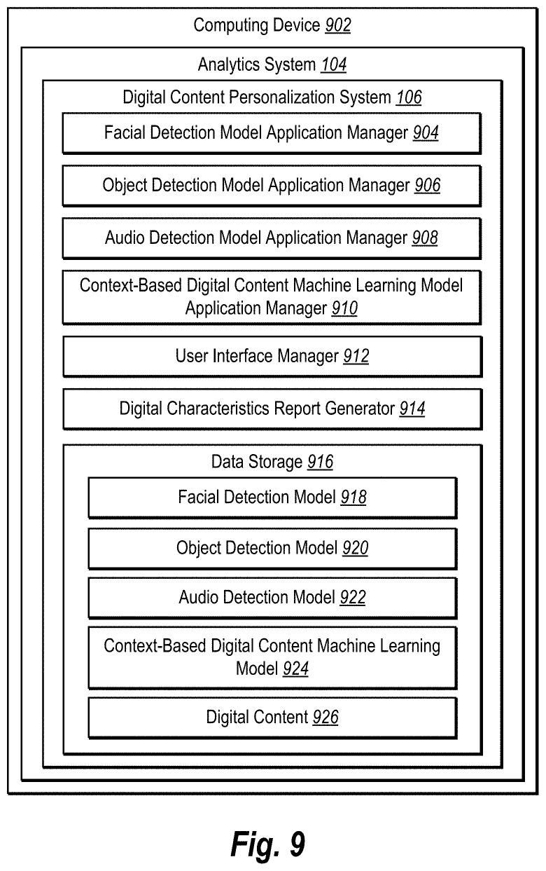

The digital content personalization system 106 can be implemented in whole, or in part, by the individual elements of the environment 100. Indeed, although FIG. 1 illustrates the digital content personalization system 106 implemented with regards to the server(s) 102, different components of the digital content personalization system 106 can be implemented in any of the components of the environment 100. The components of the digital content personalization system 106 will be discussed in more detail with regard to FIG. 9 below.

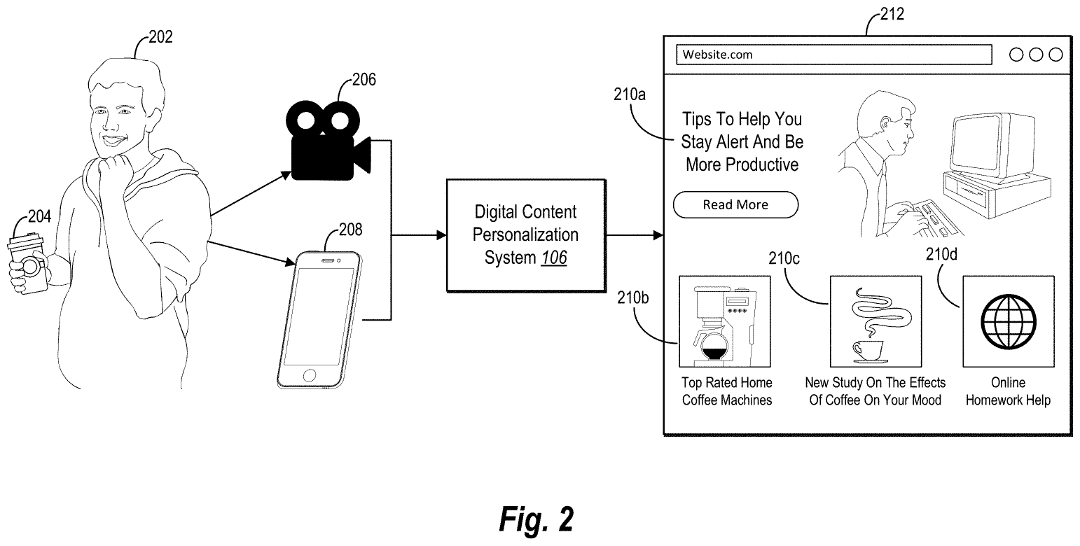

As mentioned above, the digital content personalization system 106 generates personalized digital content for display via a client device. FIG. 2 illustrates a block diagram of the digital content personalization system 106 generating personalized digital content in accordance with one or more embodiments.

As shown in FIG. 2, a digital media input device 206 can generate a stream of digital media—which can include a digital video, audio content, or both—portraying the user 202. In particular, the stream of digital media portrays the user 202 while the user 202 is accessing one or more websites via the client device 208. The stream of digital media further portrays the object 204 associated with the user 202 while the user 202 is accessing the one or more websites. As shown in FIG. 2, the object 204 represents a cup of coffee held by the user 202.

In one or more embodiments, the digital content personalization system 106 uses the stream of digital media generated by the digital media input device 206 to generate digital content 210a-210d. In particular, the digital content 210a-210d includes digital content (i.e., articles, images, text, links, videos, etc.) that is relevant to the user 202, where the digital content personalization system 106 determines the relevancy based on the stream of digital media. In particular, the digital content 210a-210d includes digital content determined to be currently relevant to the user 202. As shown in FIG. 2, the digital content personalization system 106 can provide the digital content 210a-210d for display on a website 212.

In one or more embodiments, the digital content personalization system 106 provides the digital content 210a-210d for display on the website 212 by modifying the one or more websites being accessed by the user 202 and providing the modified one or more websites for display via the client device 208. To illustrate, in some embodiments, upon access of a website by the user 202 via the client device 208, the digital content personalization system 106 provides a default website (e.g., via the third-party network server 110) for display via the client device 208. Then, as the digital media input device 206 begins to generate a stream of digital media, the digital content personalization system 106 can utilize the stream of digital media to generate the digital content 210a-210d and modify the website being accessed by the user 202 to include the digital content 210a-210, thereby generating the website 212.

In one or more embodiments, the digital content personalization system 106 provides the same default website to every user before modifying the website to include the personalized digital content 210a-210d. In some embodiments, however, the digital content personalization system 106 generates a default website based on stored user information. For example, the digital content personalization system 106 can generate a default website based on information stored within an online profile corresponding to the user 202 and/or a browser history associated with the user 202. The digital content personalization system 106 can then modify the default website to generate the website 212 based on the stream of digital media generated by the digital media input device 206. Therefore, the digital content personalization system 106 can provide an initial level of personalization when the user 202 first accesses a website and then provide additional, updated personalization based on the stream of digital media. In other embodiments, the digital content personalization system 106 modifies the website 212 with personalized content and provides the modified website for display before providing the original (unmodified) website for display.

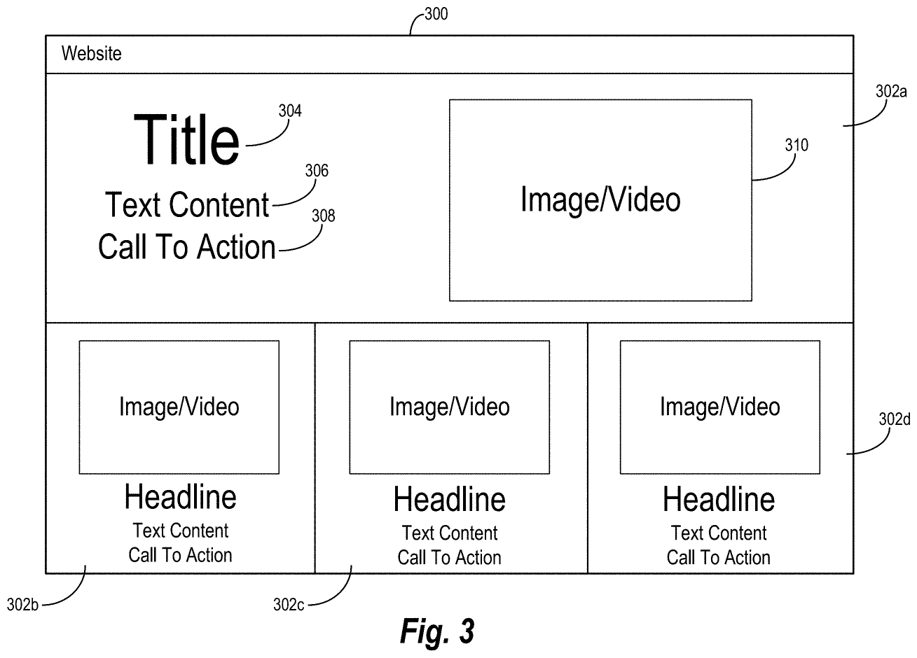

In one or more embodiments, the digital content personalization system 106 provides the personalized digital content for display on a website by inserting the personalized digital content into a pre-determined website template. FIG. 3 illustrates a website template 300 used for displaying personalized digital content in accordance with one or more embodiments.

As shown in FIG. 3, the website template 300 includes a plurality of content slots 302a-302d. The digital content personalization system 106 can insert digital content into one or more of the content slots 302a-302d for display via a client device. In one or embodiments, the digital content personalization system 106 utilizes the website template 300 to generate a default website to be provided for display when a user first accesses one or more websites via the client device. In particular, the digital content personalization system 106 can insert default digital content into each of the content slots 302a-302d and provide the resulting default website for display via the client device. The digital content personalization system 106 can further utilize the website template 300 for modifying the one or more websites accessed by the user in order to provide personalized digital content. For example, in some embodiments, the digital content personalization system 106 inserts personalized digital content into each of the content slots 302a-302d to generate a personalized website and replaces the default website with the personalized website. In other embodiments, the digital content personalization system 106 modifies the default website by replacing the default digital content in or more of the content slots 302a-302d with personalized digital content so that the modified website includes both default digital content and personalized digital content. In further embodiments, the digital content personalization system 106 does not provide a default website. Rather, in response to a user first accessing the one or more websites (e.g., entering a URL), the digital content personalization system 106 inserts personalized digital content into each of the content slots 302a-302d and provides the resulting website to the user via the client device.

Although FIG. 3 illustrates each of the content slots 302a-302d encompassing several digital content elements (i.e., a title, text, a call to action, or an image or video), it should be noted that each of the content slots 302a-302d can include any number and any combination of digital content elements. Further, in one or more embodiments, each digital content element represents its own content slot and can be changed or modified independently of any of the other content slots. For example, in some embodiments, the digital content personalization system 106 can modify the title 304 without modifying the text 306, the call to action 308, and the image/video 310 in order to provide a title that is more interesting to a user.

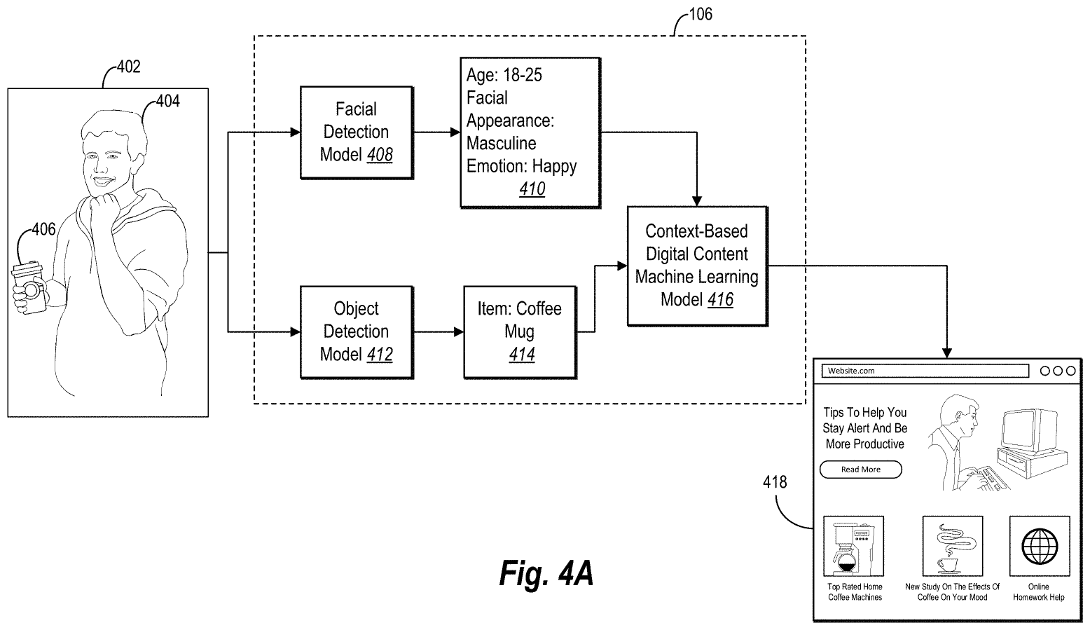

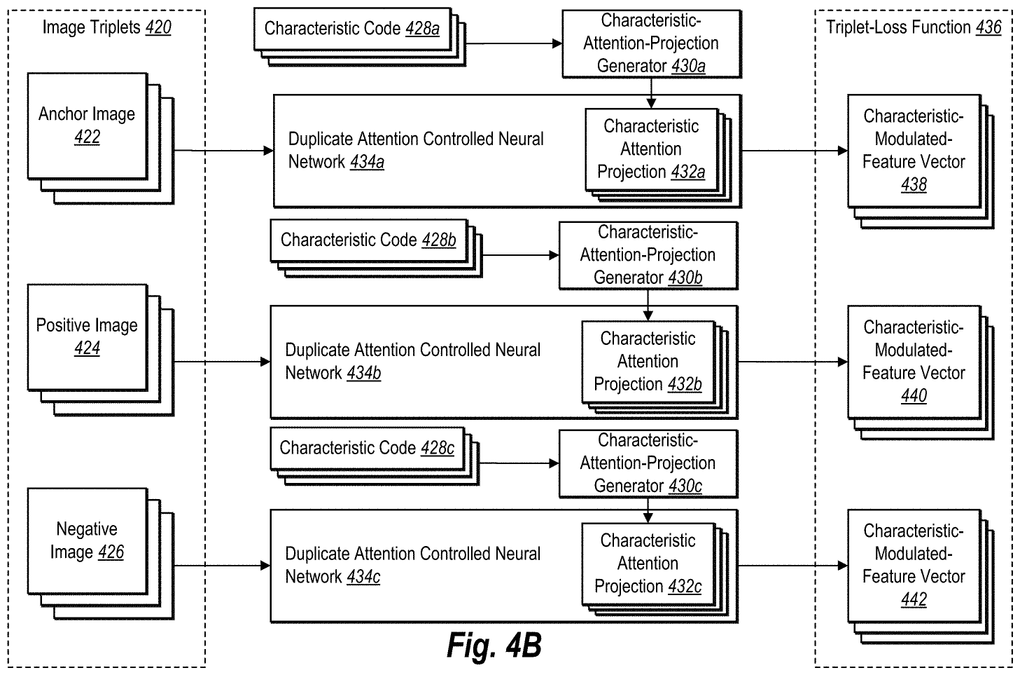

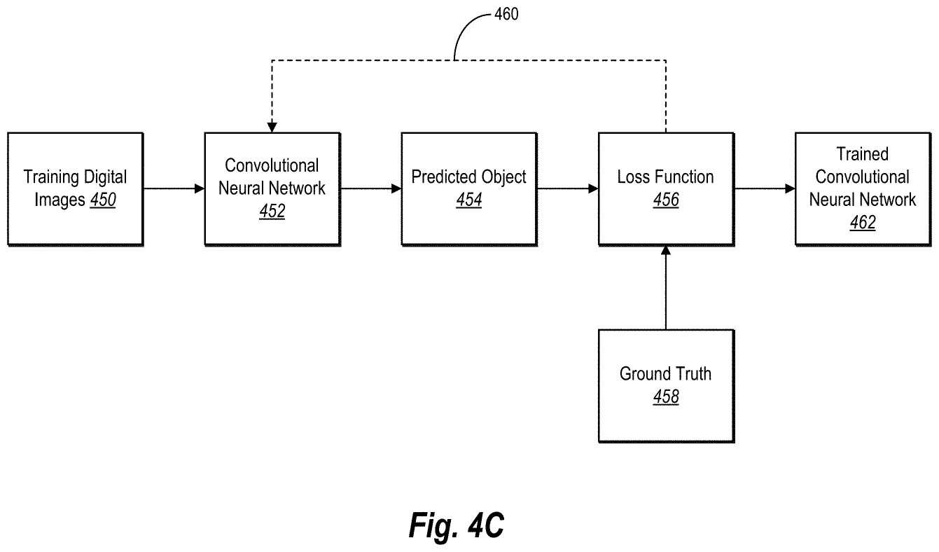

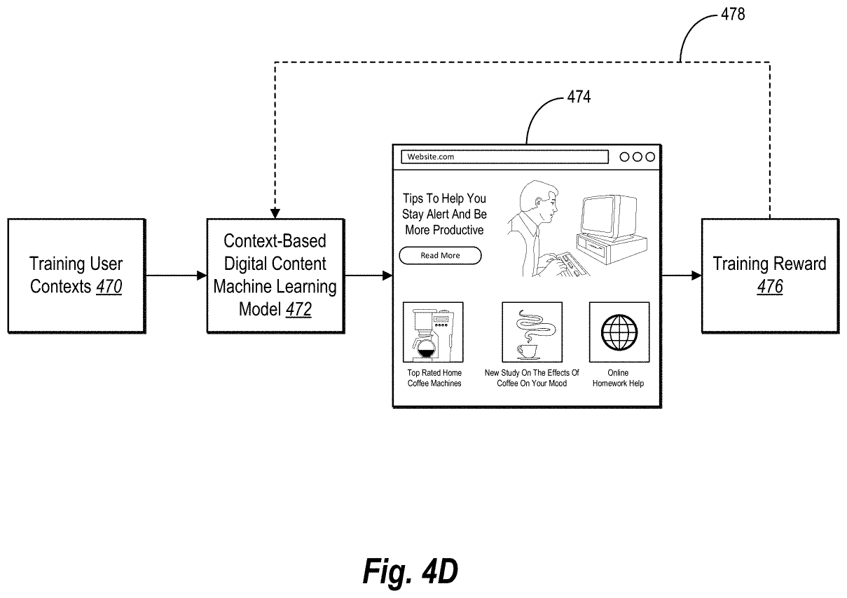

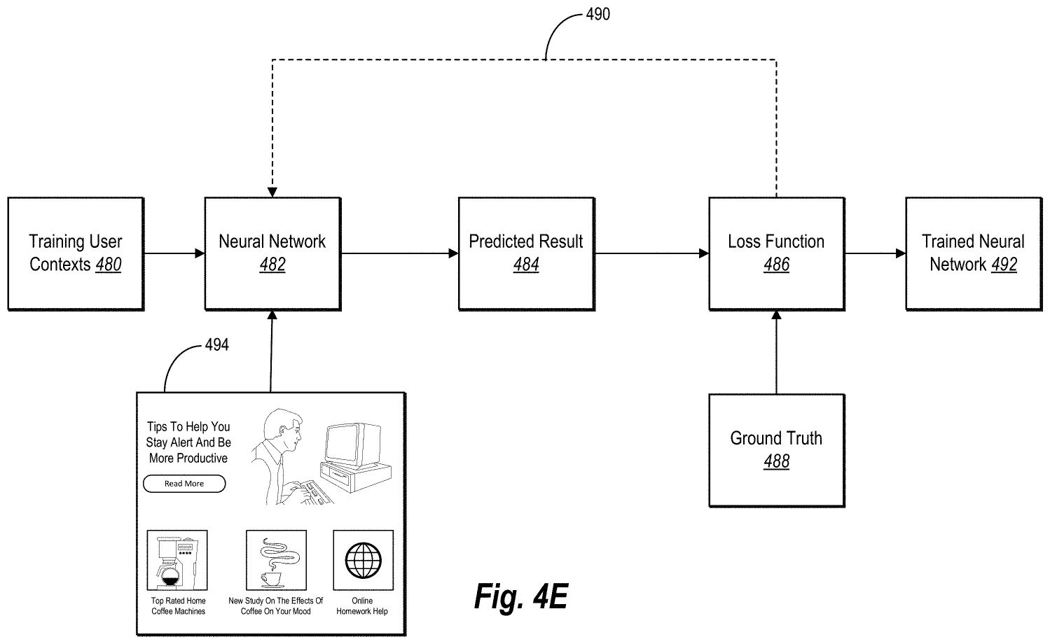

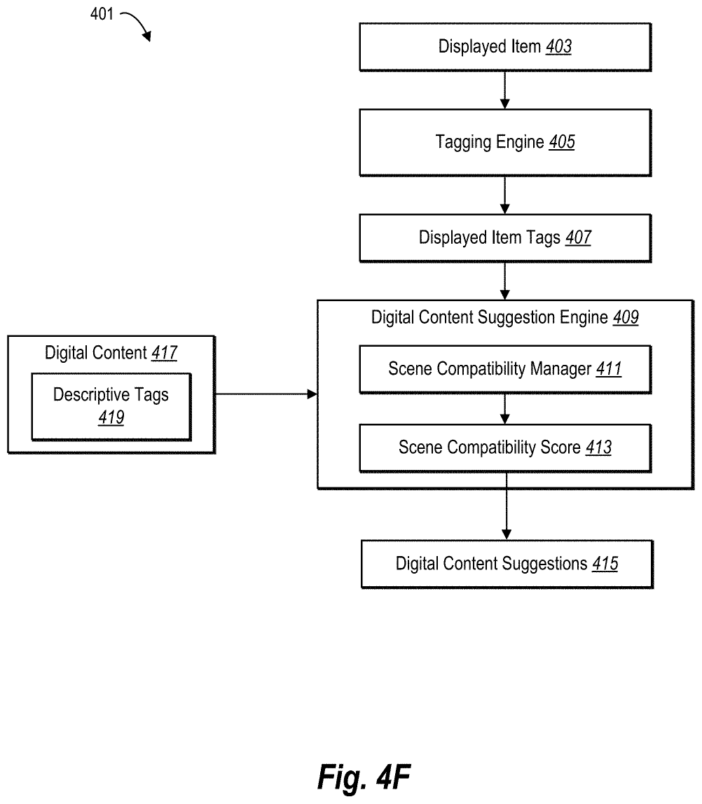

As mentioned above, in one or more embodiments, the digital content personalization system 106 generates personalized digital content by generating digital content based on a live user context. The digital content personalization system 106 can identify the live user context by analyzing a stream of digital media—which can include digital video and/or audio content—portraying the user while the user accesses one or more websites. FIG. 4A illustrates a block diagram for analyzing a digital video to generate personalized digital content in accordance with one or more embodiments.

For example, in relation to FIG. 4A the digital content personalization system 106 analyzes the digital video 402 to identify characteristics of the user 404 portrayed in the digital video 402 (as exemplified by the identified facial characteristics 410). In particular, as shown in FIG. 4A, the digital content personalization system 106 analyzes the digital video 402 utilizing a facial detection model 408 to identify facial characteristics of the user 404 portrayed in the digital video 402. In one or more embodiments, the facial detection model 408 can operate to analyze multiple faces to identify facial characteristics of multiple users portrayed in the digital video 402. The facial detection model 408 can include any facial detection model that can detect faces in digital videos and analyze the faces to identify facial characteristics. For example, in one or more embodiments, the facial detection model 408 includes a machine learning model.

In particular, in one or more embodiments, the facial detection model 408 comprises a machine learning model (e.g., a neural network) that has learned feature representations directly from training data. In particular, the digital content personalization system 106 can utilize hierarchical feature learning to train the facial detection model 408 to classify different attributes, such as emotion, age, gender, etc.

For example, the digital content personalization system 106 can access (e.g., receive or retrieve) training images and detect facial bounding boxes and landmarks for each training image. The digital content personalization system 106 can then perform an analysis (e.g., Procrustes analysis) to align the detected landmarks to a reference mean shape in order to account for variations in 2D translations, rotations, and scales. Subsequently, the digital content personalization system 106 can perform hierarchical feature learning separately in a local window at each landmark location. As a result, the number of encoders obtained from the feature learning processes is the same as the number of extracted landmarks in each face. Given a face image, the digital content personalization system 106 can utilize these encoders to obtain the local feature representations at the corresponding landmarks. The digital content personalization system 106 then concatenates the local features at all of the landmarks into a single feature vector representing the whole face. Subsequently, the digital content personalization system 106 utilizes the feature vectors of all training images to learn a set of classifiers—one for each facial attribute.

To provide another example, in one or more embodiments, the facial detection model 408 comprises an attention controlled neural network. FIG. 4B illustrates a block diagram for training an attention controlled neural network using image triplets and a triplet-loss function. As used herein, the term “attention controlled neural network” refers to a neural network trained to generate attention controlled features corresponding to a characteristic category. In particular, an attention controlled neural network is trained to generate characteristic-modulated-feature vectors corresponding to characteristic categories of a digital input image.

As shown in FIG. 4B, the digital content personalization system 106 uses image triplets 420 as inputs for a training iteration. For a training iteration, for example, the image triplets 420 include an anchor image 422, a positive image 424, and a negative image 426. In certain embodiments, the anchor image 422 and the positive image 424 both comprise a same characteristic corresponding to a characteristic category. By contrast, in some embodiments, the negative image 426 comprises a different characteristic corresponding to the characteristic category. To illustrate, the anchor image 422 and the positive image 424 may both include a face with a smile corresponding to a mouth-expression category, while the negative image 426 includes a face without a smile corresponding to the mouth-expression category. The image triplet of the anchor image 422, the positive image 424, and the negative image 426 may also include characteristics that correspond to any other characteristic category.

As further shown in FIG. 4B, in each training iteration, the digital content personalization system 106 uses characteristic-attention-projection generators 430a, 430b, and 430c to generate characteristic attention projections 432a, 432b, and 432c, respectively. As used herein, the term “characteristic attention projection” refers to a projection, vector, or weight specific to a characteristic category or a combination of characteristic categories. In some embodiments, for instance, a characteristic attention projection maps a feature of a digital image to a modified version of the feature. For example, a characteristic attention projection can include a scaling vector or a projection matrix. In one or more embodiments, the characteristic attention projections 432a, 432b, and 432c are based on characteristic codes 428a, 428b, and 428c, respectively. As used herein, an “characteristic code” refers to a reference or label for a characteristic category or a combination of characteristic categories. For example, a characteristic code can include a numeric reference, an alphanumeric reference, a binary code, or any other suitable label. While the anchor image 422, the positive image 424, and the negative image 426 may differ from each other, the characteristic codes 428a, 428b, and 428c for a given training iteration each correspond to the same characteristic category for the image triplet.

In one or more embodiments, the digital content personalization system 106 inserts the characteristic attention projections 432a, 432b, and 432c into duplicate attention controlled neural networks 434a, 434b, and 434c, respectively. The duplicate attention controlled neural network 434a, 434b, and 434c each include a copy of the same parameters and layers and receive the same updated parameters through iterative training. Accordingly, in some embodiments, the digital content personalization system 106 inserts the characteristic attention projections 432a, 432b, and 432c between the same set of layers within the duplicate attention controlled neural networks 434a, 434b, and 434c.

Subsequently, the duplicate attention controlled neural networks 434a, 434b, and 434c analyze and extract features from the anchor image 422, the positive image 424, and the negative image 426, respectively. The duplicate attention controlled neural networks 434a, 434b, and 434c then apply the characteristic attention projections 432a, 432b, and 432c, respectively, to some (or all) of the extracted features and output characteristic-modulated-feature vectors 438, 440, and 442, respectively. The characteristic-modulated-feature vectors 438, 440, and 442 correspond to the anchor image 422, the positive image 424, and the negative image 426, respectively.

The digital content personalization system 106 then determines a triple loss using a triplet-loss function 436. Subsequently, the digital content personalization system 106 back propagates the triplet loss to update the characteristic attention projections 432a, 432b, and 432c and the parameters of the duplicate attention controlled neural networks 434a, 434b, and 434c. By providing the updates, the digital content personalization system 106 incrementally minimizes the error produced by the duplicate attention controlled neural networks 434a, 434b, and 434c.

Referring back to FIG. 4A, once trained, the digital content personalization system 106 can utilize the facial detection model 408 to analyze the digital video 402 to identify characteristics of the user 404 portrayed in the digital video 402. In particular, the facial detection model 408 can analyze a face within an image (e.g., a frame of the digital video 402) to identify landmarks and then align the landmarks. The facial detection model 408 can then utilize the encoders and classifiers trained during the training process to identify the characteristics of the user 404.

In particular, in one or more embodiments, the facial detection model 408 operates as described by H. Tho, Face Recognition and Facial Attribute Analysis from Unconstrained Visual Data, DRUM, 2014, which is incorporated herein by reference in its entirety. In some embodiments, the facial detection model 408 operates as described by U. Mahbub et al., Segment-based Methods for Facial Attribute Detection from Partial Faces, IEEE Transactions on Affective Computing, 2018, CoRR abs/1801.03546.https://arxiv.org/abs/1801.03546, which is incorporated herein by reference in its entirety.

Further, as shown in FIG. 4A, the digital content personalization system 106 can analyze the digital video 402 to identify an object 406 portrayed in the digital video 402 (as exemplified by the identified object 414). In particular, the digital content personalization system 106 can analyze the digital video 402 utilizing an object detection model 412 to identify the object 406 portrayed in the digital video 402. The object detection model 412 can identify a hand-held object held by the user 404 (e.g., the object 406), a background object, an additional person, clothing, an animal, or a picture of an object. In one or more embodiments, the digital content personalization system 106 can further utilize the object detection model 412 to detect location information, lighting information, styles, and textures. In one or more embodiments, the object detection model 412 can operate to identify multiple objects portrayed in the digital video 402.

The object detection model 412 can include any object detection model that can identify objects in digital videos. For example, in one or more embodiments, the object detection model 412 can include a neural network classifier trained to identify objects.

As an example, in one or more embodiments, the digital content personalization system 106 trains the object detection model 412 by training a neural network (e.g., a convolutional neural network) to detect and classify objects portrayed in a digital video. FIG. 4C illustrates a block diagram for training a convolutional neural network to detect and classify objects in accordance with one or more embodiments. In particular, the digital content personalization system 106 can train the convolutional neural network 452 using training digital images 450, which can include frames of one or more digital videos. For example, the digital content personalization system 106 can utilize images from ADOBE® STOCK® as the training digital images.

In one or more embodiments, to improve the training of the convolutional neural network 452, the digital content personalization system 106 recursively applies k-means clustering on the training digital images 450. For example, the digital content personalization system 106 can apply a first k-means iteration to generate a first cluster of training digital image. The digital content personalization system 106 then applies a second k-means iteration on the remaining training digital images. The digital content personalization system 106 repeats this process until all training digital images are placed into a cluster and uses the clusters to train the convolutional neural network 452. In particular, the recursive application of k-means clustering to cluster the training digital images results in even groups (or, at least, near-even groups) of training digital images so that the convolutional neural network 452 is trained to detect each desired object in a balanced manner. Additionally, the recursive k-means clustering approach ensures that the convolutional neural network 452 is trained to detect even rare objects.

The digital content personalization system 106 can utilize the convolutional neural network 452 to generate a predicted object 454 from one of the training digital images (i.e., predict an object portrayed in the particular training digital image) and then compare the predicted object 454 to a ground truth 458 (i.e., an object confirmed to be portrayed in the particular training digital image) using a loss function 456. The digital content personalization system 106 can then back propagate the determined loss (as indicated by the dashed line 460) to the convolutional neural network 452 to modify its parameters. As the digital content personalization system 106 iteratively utilizes the convolutional neural network 452 to predict image tags from the training digital images 450 and back propagates the resulting loss to modify the convolutional neural network parameters, the digital content personalization system 106 generates a trained convolutional neural network 462 for detecting and classifying objects.

To provide another example, in one or more embodiments, the digital content personalization system 106 trains the object detection model 412 by extracting a large number of possibly overlapping, square subwindows of random sizes and at random positions from training images. The digital content personalization system 106 then randomly positions each subwindow so that each subwindow is fully contained in the corresponding training image. Subsequently, the digital content personalization system 106 normalizes the subwindows by resizing each subwindow to a fixed scale (e.g., 16×16 pixels) and transforms the resized subwindows to an HSV color space. The digital content personalization system 106 then labels each subwindow with the class of its parent image and applies a supervised machine learning algorithm to train the object detection model 412. In one or more embodiments, the digital content personalization system 106 utilizes an images data set to train the machine learning model(s) used by the object detection model 412. For example, the digital content personalization system 106 can utilize ADOBE® STOCK® to train the machine learning models. Once trained, the digital content personalization system 106 can utilize the object detection model 412 to analyze the digital video 402 to identify objects portrayed in the digital video 402.

In particular, in one or more embodiments, the object detection model 412 operates as described by R. Maree et al., Random Subwindows for Robust Image Classification, 2005 IEEE Computer Society Conference on Computer Vision and Pattern Recognition, which is incorporated herein by reference in its entirety. In some embodiments, the object detection model 412 operates as described by J. Krause et al., Fine-grained Recognition without Part Annotations, CVPR, 2015, which is incorporated herein by reference in its entirety.

In some embodiments, the object detection model 412 implements a “you only look once” (YOLO) approach. In particular, the object detection model 412 applies a single neural network to an entire digital image (e.g., rather than applying the neural network to the image at multiple locations and scales, which is the implementation used by many conventional systems). The neural network divides the image into regions (e.g., a grid of regions) and predicts bounding boxes and probabilities for each region. In particular, the predicted probabilities reflect a confidence that its corresponding bounding box contains an object. The neural network then determines objects that are within the digital image using the bounding boxes and the predicted probabilities.

As shown in FIG. 4A, in one or more embodiments, the identified facial characteristics 410 and the identified object 414 define a live user context. The digital content personalization system 106 can utilize the context-based digital content machine learning model 416 to generate the digital content 418—shown to be displayed in a website (e.g., the one or more websites being accessed by the user 404)—based on the identified facial characteristics 410 and the identified object 414. In one or more embodiments, the context-based digital content machine learning model 416 comprises a neural network trained to select digital content based on live user contexts.

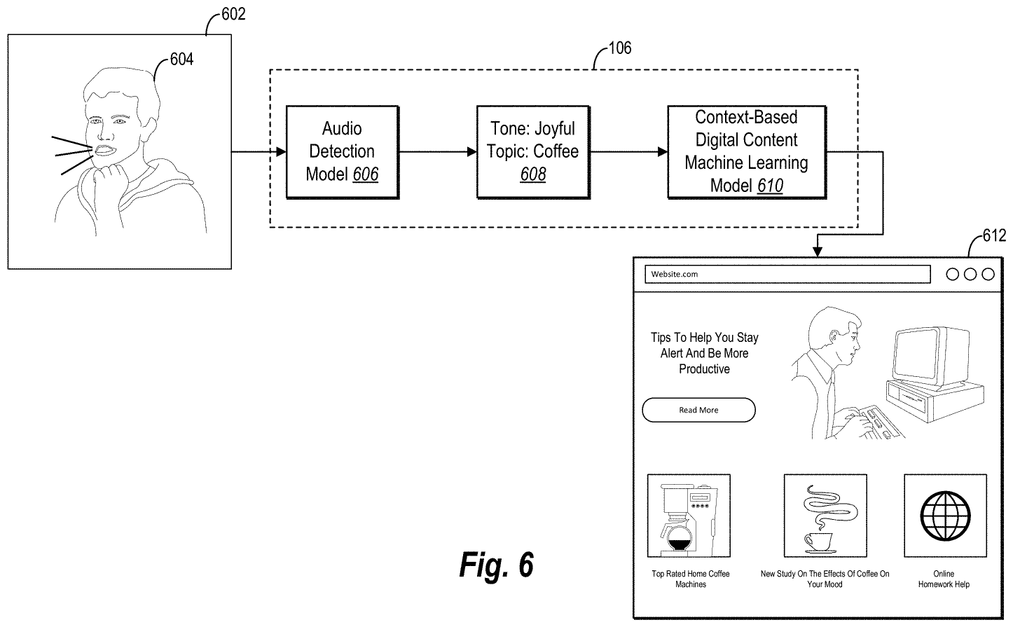

For example, the digital content personalization system 106 can train a reinforcement learning model utilizing training user contexts. FIG. 4D illustrates a block diagram for training a context-based digital content machine learning model using reinforcement learning in accordance with one or more embodiments. As shown in FIG. 4D, the digital content personalization system 106 utilizes a context-based digital content machine learning model 472 to generate proposed digital content 474 based on training user contexts 470 (e.g., training user characteristics). In particular, the training user contexts 470 can include training sets of facial characteristics of users and training sets of objects that are identifiable by a facial detection model and an object detection model 412, respectively (e.g., the facial detection model 408 and the object detection model 412 of FIG. 4A). In one or more embodiments, the training user contexts 470 further include training sets of additional characteristics of users that are identifiable by an audio detection model (discussed in more detail with regard to FIG. 6).

After generating the proposed digital content 474, the digital content personalization system 106 can observe a training reward 476 resulting from the proposed digital content 474, where the training reward 476 corresponds to the occurrence of a desired event after display of the proposed digital content 474 (e.g., clicks, views, the purchase of a product or service, etc.). The digital content personalization system 106 can modify the context-based digital content machine learning model 472 based on the observed training reward 476 (as indicated by the dashed line 478). In particular, the digital content personalization system 106 can iteratively train the context-based digital content machine learning model 472 to maximize the reward produced by the proposed digital content 474. For instance, the digital content personalization system can utilize a policy gradient that modifies a policy for selecting the digital content in an effort to increase (maximize) the resulting reward. To illustrate, the digital content personalization system 106 can utilize Monte Carlo reinforcement learning that includes a policy gradient to generate an optimized policy (after various iterations) to train the context-based digital content machine learning model. Thus, the digital content personalization system 106 trains the context-based digital content machine learning model 472 to generate personalized digital content based on live user contexts.

As shown in FIG. 4D, the digital content personalization system 106 can train the context-based digital content machine learning model 472 on the fly. In other words, the digital content personalization system 106 can provide the proposed digital content 474 to a user via a client device (e.g., through a web site) and observe the response of the user. The digital content personalization system 106 utilizes the response of the user as the training reward 476. Accordingly, the context-based digital content machine learning model 472 corresponds to the context-based digital content machine learning model 416 of FIG. 4A.

To provide another example, FIG. 4E illustrates a block diagram for training a context-based digital content machine learning model by training a neural network (such as an LSTM network that can analyze a sequence of interactions) to generate personalized digital content in accordance with one or more embodiments. As shown in FIG. 4E, the digital content personalization system 106 can utilize a neural network 482 to generate predicted result 484 based on training user contexts 480 (e.g., the training user contexts described above) and training digital content 494. As an example, the predicted result 484 can include a prediction of how a user having a particular user context (e.g., provided by the training user contexts 480) would react to the training digital content 494. The digital content personalization system 106 can determine a loss (i.e., an error) resulting from the prediction by comparing the predicted result 484 to a ground truth 488 (e.g., an observed result from providing the digital content to a user having the particular user context) using a loss function 486. The digital content personalization system 106 can back propagate the loss to the neural network 482 (as indicated by the dashed line 490) to modify neural network parameters. Thus, by iteratively utilizing the neural network 482 to predict results and modifying neural network parameters based on a loss resulting from the prediction, the digital content personalization system 106 generates a trained neural network 492.

The digital content personalization system 106 can then use the trained neural network 492 by providing a live user context and different digital content options. The trained neural network 492 can predict results corresponding to providing the digital content options to a user having the live user context. The digital content personalization system 106 can then select to provide the digital content option having the best result prediction. Accordingly, the trained neural network 492 corresponds to the context-based digital content machine learning model 416 of FIG. 4A.

FIG. 4F provides another example illustration of a context-based digital content machine learning model. FIG. 4F depicts an example implementation 401 in which the digital content personalization system 106 generates suggestions of digital content based on items or characteristics displayed (i.e., portrayed) in a digital video. As shown, the illustrated example includes a tagging engine 405 and a digital content suggestion engine 409 and also includes a displayed item 403 (e.g., an item displayed in the digital video stream from the client device), and available digital content 417 with descriptive tags 419 (i.e., digital content items that can be provided via a website that already include descriptive tags).

In this example 400 of the context-based digital content machine learning model, the tagging engine 405 is depicted obtaining the displayed item 403. The tagging engine 405 identifies characteristics of the displayed item 403 (e.g., an image from digital video collected at the client device), determines tags that correspond to the identified characteristics, and generates one or more displayed item tags 407. In one or more implementations, the displayed item tags 407 are generated as a list of tags that can be included as part of (e.g., as metadata) or otherwise associated with a respective content item of the displayed item 403. In relation to a digital video that depicts a coffee mug, for instance, the tagging engine 405 can identify characteristics of a coffee mug using object recognition, determine that the tag ‘mug’ corresponds to the identified characteristics, and then generate a list of tags for the image that includes the tag ‘mug.’

In the illustrated example 400, the digital content suggestion engine 409 is depicted receiving the displayed item 403 and the displayed item tags 407 as input. The digital content suggestion engine 409 is also depicted receiving the digital content 417, which includes the descriptive tags 419, as input. In accordance with the described techniques, the digital content suggestion engine 409 generates digital content suggestions 415 based on the displayed item 403, the displayed item tags 407, and the digital content 417.

As illustrated, the digital content suggestion engine 409 includes the scene compatibility manager 411. The scene compatibility manager 411 determines a compatibility of different content items of the digital content 417 with the displayed item 403. In accordance with the described techniques, the scene compatibility manager 411 generates a scene compatibility score 413 for each content item of the digital content 430 that is considered in relation to a given displayed item 403. For a particular digital image of a digital video, for instance, the scene compatibility manager 411 generates a scene compatibility score 413 for each item of the digital content 417 that is a candidate based on one or more items displayed in the digital video. In this way, the scene compatibility score 413 allows each of candidate in the digital content 430 to be compared, e.g., to identify digital content that is compatible with the scene captured in the digital video at the client device.

In one or more implementations, the scene compatibility manager 411 computes the scene compatibility score 413 according to the following description. Initially, the scene compatibility manager 411 generates a representation of a given item of the digital content 417 based on a number of the descriptive tags 419 corresponding to the given content item, e.g., a number of tags in the list corresponding to the given content item. In the following discussion, the number of tags corresponding to a given item of background content 430 is represented by the term n. In at least one example, the scene compatibility manager 411 may thus generate a representation of an image as a set of tags in accordance with the following:

ImageTagsSet={T₁, T₂, T₃, . . . Tₙ}

Here, the terms T₁, T₂, T₃, Tₙ each represent different descriptive tags 419 identified for and associated with the given content item. As part of computing the scene compatibility score 413 for the given content item, the scene compatibility manager 411 determines an association of each of the tags included in the set with the displayed item. With reference to the above-noted example, for instance, the scene compatibility manager 411 determines an association of the tag T₁ with the displayed item, an association of the tag T₂ with the displayed item, an association of the tag T₃ with the displayed item, and so on, until determining an association of the tag Tₙ with the displayed item.

In one or more implementations, the scene compatibility manager 411 determines an association with a given tag as a probability. Specifically, the probability is of the given tag and a displayed item tag, representative of the displayed item, to coexist in tag lists of a repository of content items, e.g., a probability of the two tags to coexist in the tag lists of all items. The scene compatibility manager 411 generates a list of the associations for each set of image tags. This generated list is represented below by the term ItemAssociationWithTags. In connection with the image tag set expressed above, for instance, the scene compatibility manager 411 generates a list having a number of associations n corresponding to the number of tags in the ImageTagSet, where the list may be generated in one example as follows:

ItemAssocationWithTags={A₁, A₂, A₃, ... Aₙ}

Here, the terms A₁, A₂, A₃, Aₙ each represent an association (e.g., a probability) of the terms T₁, T₂, T₃, Tₙ, respectively, to coexist with the displayed item tag of the displayed item. In implementation, the scene compatibility manager 411 may select the displayed item tag 402 corresponding to the displayed item as a tag describing the item itself or a tag describing a class of items to which the listed item belongs. For a knife, for instance, the scene compatibility manager 411 may select the tag “paring knife” (e.g., as the item itself) or the tag “cutlery” or even “kitchen utensil” (e.g., as the class of the item). In one or more implementations, the scene compatibility manager 411 determines the associations A₁, A₂, A₃, Aₙ in accordance with the following:

$${A}_{1} = \frac{\# of times Itm and {T}_{1} coexist}{\# of Itm + \# of {T}_{1}}$$

Here, the term A₁ corresponds to the computed probability of the tag T₁ and the tag Itm, selected to represent the displayed item, to coexist in lists of image tags of available content, e.g., coexist in lists of the descriptive tags 419 of the digital content 417. The scene compatibility manager 411 computes probabilities for the associations A₂, A₃, . . . Aₙ in a similar manner. The term # of times Itm and T₁ coexist represents the number of times that the tag T₁ and the tag Itm coexist in the lists of tags of the digital content 417. Consider an example in which the tag Itm is ‘knife’ and the tag T₁ is ‘kitchen,’ for instance. In this example, the scene compatibility manager 411 processes the lists of tags for the available digital content 417. Each time the scene compatibility manager 411 identifies both tags ‘knife’ and ‘kitchen’ in a list of tags describing a particular content item of the digital content 430, the scene compatibility manager 411 increments the term # of times Itm and T₁ coexist, e.g., starting at zero and adding one for each identified coexistence.

In contrast to that term, the terms # of Itm and # of T₁, represent the number of times the tag Itm and the tag T₁ exist, respectively, in the lists of tags of the background content. Thus, the term # of Itm is incremented not only when the tag Itm and the tag T₁ coexist in a list, but also when the tag Itm exists in a list but the tag T₁ is not included in that list. Similarly, the term # of T₁ is incremented not only when the tag Itm and the tag T₁ coexist in a list, but also when the tag T₁ exists in a list but the tag Itm is not included in that list.

Given a list of the associations for a given image, the scene compatibility manager 411 computes the scene compatibility score 413 as a function of the determined associations. In one example, for instance, the scene compatibility manager 411 computes the scene compatibility score 413, represented by the term SC, in accordance with the following:

SC=A₁+A₂+A₃ +. . . Aₙ

Here, the scene compatibility manager 411 computes the scene compatibility score 413 by adding the associations A₁, A₂, A₃, . . . Aₙ. However, the scene compatibility manager 411 may compute the scene compatibility score 413 in different ways without departing from the spirit or scope of the described techniques, such as by weighting associations for different types of terms (e.g., weighting terms indicative of angle, position, perspective differently than terms describing the scene or theme), adding a term to capture conversion rate of the background content 430 across websites or applications for which it is used, and so forth.

In one or more implementations, the scene compatibility manager 411 also incorporates performance measures of the background content 430 into the scene compatibility score 413, such that the scene compatibility score 413 can also reflect influence of this content to cause conversion or other responses, e.g., how well digital content causes conversion in relation to the displayed item captured in digital video. In this way, the background content 430 that is observed causing higher conversion rates may be suggested to help with conversion of a listed item.

The scene compatibility manager 411 may incorporate performance of the background content 430 into the scene compatibility score 413 in accordance with the following. Initially, the scene compatibility manager 411 identifies items of digital visual content that are already used which are “performing well.” By “performing well” it is meant that the observed conversion (e.g., purchases initiated, clicks, etc.) or conversion rate in relation to actions involving the respective content satisfies one or more criteria indicative of suitable performance. Examples of these criteria include that the conversion or conversion rate observed in relation to a content item is above a conversion threshold, higher than the than those of related listings (e.g., listings in a same category), a top k conversion or conversion rate for background content (e.g., across all stock images, across stock images used in connection with particular categories of listings such as kitchen utensils versus furniture, etc.), and so forth. It is to be appreciated that different criteria indicative of suitable performance to be “performing well” may be used without departing from the spirit or scope of the described techniques.

In order to incorporate content performance into the scene compatibility score 413, the scene compatibility manager 411 generates a table based on the in-use content that is identified to be performing well. The scene compatibility manager 411 generates this table to include category tags (e.g., in a first column), which correspond to a category of digital content with the well-performing content. This table is also generated to include tags (e.g., in a second column), which describe characteristics present in the well-performing digital content. The scene compatibility manager 411 also determines weights for each of the tags and links these determined weights with the respective tags in the table.

In one or more implementations, the scene compatibility manager 411 generates this table in accordance with the following discussion, namely, by performing the following procedure for each identified item of well-performing content. The scene compatibility manager 411 identifies items of the digital content 417 (e.g., stock images) that are similar to this well-performing content. For each of the identified similar content items, the tagging engine 405 generates a list of tags describing the respective content item.

The scene compatibility manager 411 then processes each tag by initially determining whether the tag is already included in the table with the tags (e.g., in the table's second column). If a tag is not yet included in the table for the category, the scene compatibility manager 411 adds the tag to the table (e.g., in the row corresponding to the category and the second column). For these newly added tags, the scene compatibility manager 411 also sets a weight of the tag equal to one (“1”). If the tag is already included in the table for the category, however, the scene compatibility manager 411 increments the weight of the tag by one (“1”). Thus, the more often a particular tag is identified in the lists describing the similar images the greater the tag's weight for the category.

Using this table, the scene compatibility manager 411 can further apply performance weights to the above discussed associations of background content tags, such as to apply more weight to associations computed for tags that are used frequently in content similar to the well-performing content. The scene compatibility manager 411 can be trained not only to weight tags because they describe characteristics common to well-performing content items, but also to weight tags in a variety of other ways without departing from the spirit or scope of the described techniques.

For example, the scene compatibility manager 411 may leverage machine learning techniques to determine weights to associate with the tags of a given item of digital content. The scene compatibility manager 411 can use any type of machine learning techniques capable of learning how the presence of different tags describing digital visual content, e.g., to learn how the presence of a tag correlates to conversion. According to various implementations, such techniques may use a machine-learning model trained using supervised learning, unsupervised learning, and/or reinforcement learning. For example, the machine-learning model can include, but is not limited to, auto encoders, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. The scene compatibility manager 411 may use machine learning techniques to continually train and update the machine-learning model (or, in other words, to update a trained machine-learning model) to more accurately reflect the suitability of background content for combining with items to be listed and listed for different purposes, e.g., sale of an item, rent of an item, and so forth. Referring back to FIG. 4A, once trained, the digital content personalization system 106 utilizes the context-based digital content machine learning model 416 to generate digital content (e.g., the digital content 418) based on live user contexts (e.g., a live user context defined by the identified facial characteristics 410 and the identified object 414). In one or more embodiments, the context-based digital content machine learning model 416 generates the digital content by selecting a subset of digital content from a repository of digital content based on the identified facial characteristics 410 and the identified object 414. In one or more embodiments, the context-based digital content machine learning model 416 operates in the same manner as ADOBE® TARGET®.

In one or more embodiments, the digital content personalization system 106 utilizes the context-based digital content machine learning model 416 to generate personalized digital content further based on a manual input provided by the user 404 via a client device (i.e., the live user context can further be defined by manual input). For example, the digital content personalization system 106 can receive manual input from the user 404 portrayed in the digital video 402 via a client device while the user 404 accesses one or more websites. The digital content personalization system 106 can then utilize the context-based digital content machine learning model 416 to select a subset of digital content from the repository of digital content based on the manual input, the identified facial characteristics 410, and the identified object 414. In further embodiments, the digital content personalization system 106 utilizes the context-based digital content machine learning model 416 to generate personalized digital content further based on stored user information (e.g., a user profile, browser history, etc.).

Thus, the digital content personalization system 106 can train a context-based digital content machine learning model to generate digital content based on user contexts. In particular, the digital content personalization system 106 can utilize training user contexts to train the context-based digital content machine learning model. The algorithms and acts described with reference to FIGS. 4D-4F can comprise the corresponding structure for performing a step for training a context-based digital content machine learning model to generate digital content in response to training user context.

Further, the digital content personalization system 106 can utilize a context-based digital content machine learning model to generate digital content based on a live user context (e.g., defined based on digital media portraying a user while the user accesses one or more websites). In particular, the digital content personalization system 106 can generate the personalized digital content for display while a user accesses one or more websites. The algorithms and acts described with reference to FIGS. 2 and 4A can comprise the corresponding structure for performing a step for utilizing the context-based digital content machine learning model to generate digital content for display while the user accesses the one or more websites via the client device based on the identified characteristics of the user.

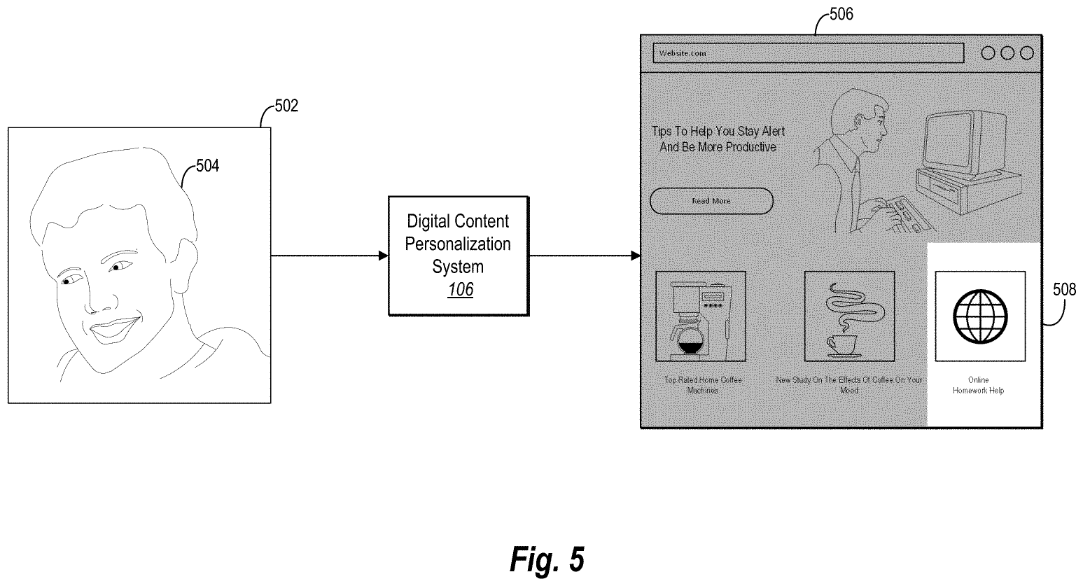

In one or more embodiments, the digital content personalization system 106 generates personalized digital content based on a gaze of the user. FIG. 5 illustrates a block diagram for utilizing a gaze of a user to generate personalized digital content in accordance with one or more embodiments. In particular, as shown in FIG. 5, the digital content personalization system 106 analyzes a digital video 502 portraying a user 504 to identify a gaze of the user 504. In one or more embodiments, the digital content personalization system 106 utilizes a facial detection model (e.g., the facial detection model 408 of FIG. 4A) to identify the gaze of the user. In some embodiments, the digital content personalization system 106 includes a separate head tracking model or an eye tracking model, to analyze the digital video 502 and identify the gaze of the user 504.

To illustrate, the digital content personalization system 106 can perform a calibration operation by showing the user 504 a set of targets (e.g., dots or other images) distributed over the display of the client device associated with the user 504. The digital content personalization system then 106 requests that the user 504 gaze at each of the targets for a specified period of time. As the user 504 gazes at each target point, the digital content personalization system 106 can then capture the various associated eye positions and then map those eye positions to corresponding gaze coordinates, thus learning a mapping function.

After calibration is complete, the digital content personalization system 106 can capture video frames of the face and eye regions of the user 504 (e.g., while the user is accessing one or more websites via the client device). The digital content personalization system 106 can then perform eye detection to determine the eye position for each frame and utilize the mapping to determine the corresponding gaze coordinates. In particular, in one or more embodiments, the digital content personalization system 106 utilizes the Pupil Center Corneal Reflection (PCCR) method, using near infra-red (NIR) LEDs to produce glints on the eye cornea surface of the user 504 and then capture images, video of the eye region. For example, in some embodiments, the digital content personalization system 106 utilizes external NR illumination with single/multiple LEDs (e.g., having a wavelength in the range of 850+/−30 nm). The digital content personalization system 106 can then estimate the gaze of the user 504 based on the relative movement between the pupil center and the glint positions.

In particular, in one or more embodiments, the digital content personalization system 106 (i.e., the head tracking or eye tracking component of the digital content personalization system 106, which may be integrated as part of a facial detection model) operates as described by A. Kar & P. Corcoran, A Review and Analysis of Eye-gaze Estimation Systems, Algorithms, and Performance Evaluation Methods in Consumer Platforms, IEEE Access, 2017, which is incorporated herein by reference in its entirety. In some embodiments, the digital content personalization system 106 operates as described by C. H. Morimoto & M. R. M. Mimica, Eye Gaze Tracking Techniques for Interactive Applications, Computer Vision and Image Understanding, 2002, which is incorporated herein by reference in its entirety.

After identifying the gaze of the user 504 portrayed in the digital video 502, the digital content personalization system 106 can generate the digital content 506 based on the identified gaze. Specifically, the digital content personalization system 106 generates the digital content 506 displayed in a website (e.g., the one or more websites being accessed by the user 504). For example, in relation to the embodiment of FIG. 5, the digital content personalization system 106 identifies digital content elements 508 of the one or more websites associated with the gaze of the user 504 (i.e., targeted by the gaze of the user 504). The digital content personalization system 106 then utilizes a context-based digital content machine learning model (e.g., the context-based digital content machine learning model 416 of FIG. 4A) to select a subset of digital content (e.g., based on other characteristics of the user and/or objects identified from the digital video 502) and replace the digital content elements 508 with the subset of digital content. In one or more embodiments, however, in response to the user 504 (i.e., the client device of the user) first accessing the one or more websites (e.g., entering a URL and requesting the website from a remote server), the digital content personalization system 106 selects the digital content elements 508 to be initially presented to the user 504 within the one or more websites (i.e., the digital content elements 508 represents personalized digital content).

In some embodiments, the digital content personalization system 106 can modify the digital content elements 508 based on the gaze of the user. For example, the digital content personalization system 106 can zoom into the digital content elements 508, highlight the digital content elements 508 (and/or blur out or shade the surrounding digital content), or move the digital content elements 508 based on the identified gaze of the user. In some embodiments, the digital content personalization system 106 can receive a voice command from the user 504 and, while the user 504 is accessing the one or more websites, modify the digital content elements 508 based on the voice command. Thus, the digital content personalization system 106 can receive input from the user 504 without the use of a hardware peripheral (e.g., mouse or keyboard). It should be noted that, though FIG. 5 illustrates identifying and manipulating a plurality of digital content elements, the digital content personalization system 106 can operate similarly for any individualized digital content element.

As mentioned above, in one or more embodiments, the stream of digital media includes audio content portraying a user while the user accesses one or more website. The digital content personalization system 106 can further define the live user context by analyzing the audio content. FIG. 6 illustrates a block diagram for analyzing audio content 602 to generate personalized digital content in accordance with one or more embodiments. As shown in FIG. 6, the digital content personalization system 106 utilizes an audio detection model 606 to analyze the audio content 602.

As an illustration, FIG. 6 shows that the digital content personalization system 106 utilizes the audio detection model 606 to analyze the audio content 602 in order to identify characteristics of the user 604 (as exemplified by the identified characteristics 608). These characteristics may be different than, or similar to, the characteristics identified by analyzing a digital video portraying the user 604. For example, the audio detection model 606 can identify an emotion of the user 604 portrayed in the audio content 602. Further, the audio detection model 606 can identify a tone of voice of the user 604 or the words used or topic of speech. The audio detection model 606 can include any model capable of analyzing audio content to identify emotion, tone, words, or topics.

For example, in one or more embodiments, the audio detection model 606 can include a neural network trained to analyze audio content to identify emotion, tone, words, and/or topics. In particular, the digital content personalization system 106 can utilize a neural network to generate predicted emotions, tones, words, and/or topics by analyzing training audio content. The digital content personalization system 106 can then determine a loss resulting from the prediction by comparing the predicted emotions, tones, words, and/or topics to ground truths (e.g., annotations of the training audio content). The digital content personalization system 106 can then modify parameters of the neural network based on the determined loss. By iteratively utilizing the neural network to generate predictions, determining the loss resulting from those predictions and modifying parameters of the neural network based on the determined loss, the digital content personalization system trains the neural network. Subsequently, the digital content personalization system 106 can utilize the audio detection model 606 (i.e., the trained neural network) to analyze audio content and identify emotions, tones of voice, words, and/or topics.

In addition, in one or more embodiments, the audio detection model 606 receives the audio content 602. In particular, in some embodiments, the audio content 602 includes a speech component (i.e., an audio component) and a text component (e.g., obtained using speech-to-text processing). The audio detection model 606 can then extract features from each of the components. For example, the audio detection model 606 can extract common features from the speech component, such as pitch, energy, formants, intensity, and Zero Crossing Rate (ZCR).

To extract features from the text component, the audio detection model 606 first breaks down the included text into sentences. Subsequently, the audio detection model 606 identifies each word in the sentence by its corresponding part of speech. The audio detection model 606 then removes stop words (i.e., words that don't carry significant meaning, such as determiners and prepositions). The audio detection model 606 can then extract the relevant features.

Once features have been extracted from the speech component and text component, the audio detection model 606 combines the features into a single feature vector. The audio detection model 606 then utilizes a classifier to determine an emotion of the user 604 portrayed in the audio content 602 based on the single feature vector. For example, the audio detection model 606 can utilize a multi-class support vector machine (SVM) to determine the emotion. In one or more embodiments, the digital content personalization system 106 trains the classifier to identify a tone of voice of the user 604 portrayed in the audio content 602 as well.

In particular, in one or more embodiments, the audio detection model 606 operates as described by J. Bhaskar et al., Hybrid Approach for Emotion Classification of Audio Conversation Based on Text and Speech Mining, Procedia Computer Science, 2015, which is incorporated herein by reference in its entirety. In some embodiments, the audio detection model 606 operates as described by A. Milton et al., SVM Scheme for Speech Emotion Recognition Using MFCC Features, IJCA, 2013, which is incorporated herein by reference in its entirety.

The digital content personalization system 106 then utilizes the context-based digital content machine learning model 610 to generate the digital content 612—shown to be displayed in a website (e.g., the one or more websites being accessed by the user 604)—based on the identified characteristics 608. In one or more embodiments, the digital content personalization system 106 analyzes the audio content 602 and a digital video portraying the user 604 (e.g., the digital video 402 of FIG. 4A) in parallel. In other words, the digital content personalization system 106 can define a live user context utilizing characteristics of a user and objects identified from a digital video, and additional characteristics of the user identified from audio content. The digital content personalization system 106 can then generate digital content, while the user is accessing the one or more websites, based on the live user context.

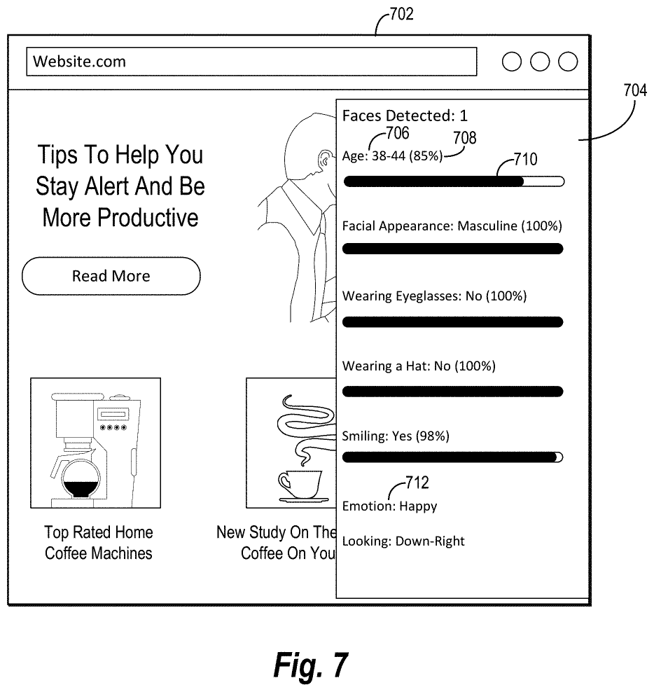

In one or more embodiments, the digital content personalization system 106 generates a digital characteristics report based on the characteristics of a user identified from a digital video and/or from audio content portraying the user while the user accesses one or more embodiments. In some embodiments, the digital content personalization system 106 provides the digital characteristics report for display via a client device. FIG. 7 illustrates a user interface through which the digital content personalization system 106 can provide a digital characteristics report 704 in accordance with one or more embodiments. As shown in FIG. 7, in one or more embodiments, the digital content personalization system 106 can provide the digital characteristics report 704 as a panel or window overlaying the digital content 702—shown to be displayed in a website (e.g., one or more websites being accessed by a user).

In particular, as shown in FIG. 7, the digital characteristics report 704 can display an identified characteristic (e.g., the characteristic 706) along with a confidence score (e.g., the confidence score 708) that provides the confidence with which the digital content personalization system 106 has identified the characteristic. Further, the digital characteristics report 704 can provide a visual indicator (e.g., the visual indicator 710) of the confidence score. As shown in FIG. 7, the digital characteristics report 704 can also include identified characteristics (e.g., the characteristic 712) without the associated confidence information. In one or more embodiments, the digital characteristics report 704 further provides similar information for objects identified in the digital video portraying the user.

In one or more embodiments, the digital content personalization system 106 can also provide a plurality of selectable privacy options (not shown) through the digital characteristics report 704. In particular, each selectable privacy option can correspond to a particular user characteristic category (e.g., age, gender, etc.). In response to detecting a selection of a selectable privacy option by a user, the digital content personalization system 106 can apply a filter to the model that identifies the corresponding user characteristic so that the model no longer identifies that characteristic when analyzing the stream of digital media. In some embodiments, the digital content personalization system 106 can further provide one or more selectable privacy options that correspond to object detection. A user can also select a privacy option to prohibit capturing and/or analyzing a digital media stream or determining any user characteristics. In one or more embodiments, the digital content personalization system 106 operates in response to selection of an opt-in selectable privacy option.

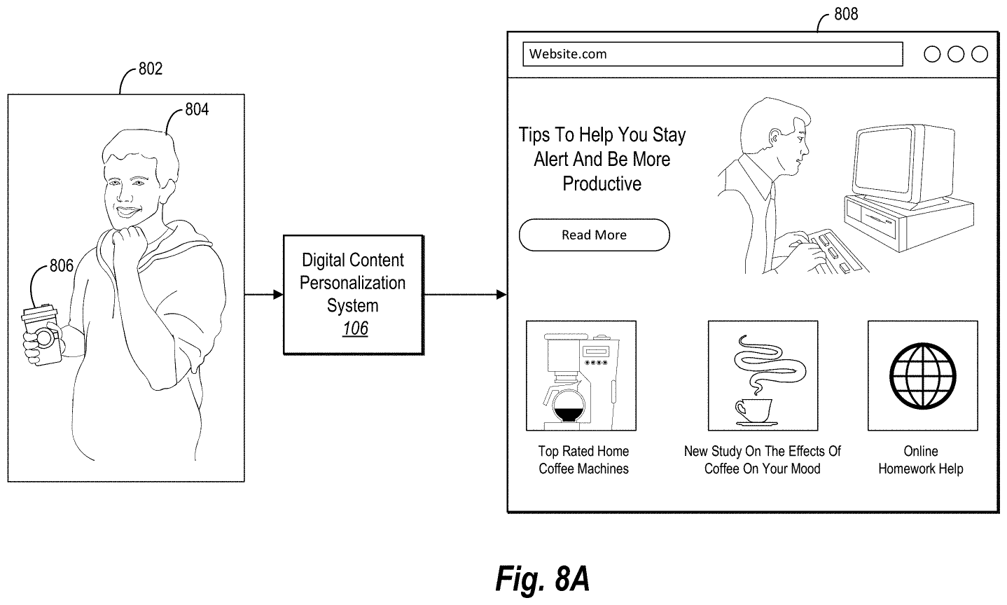

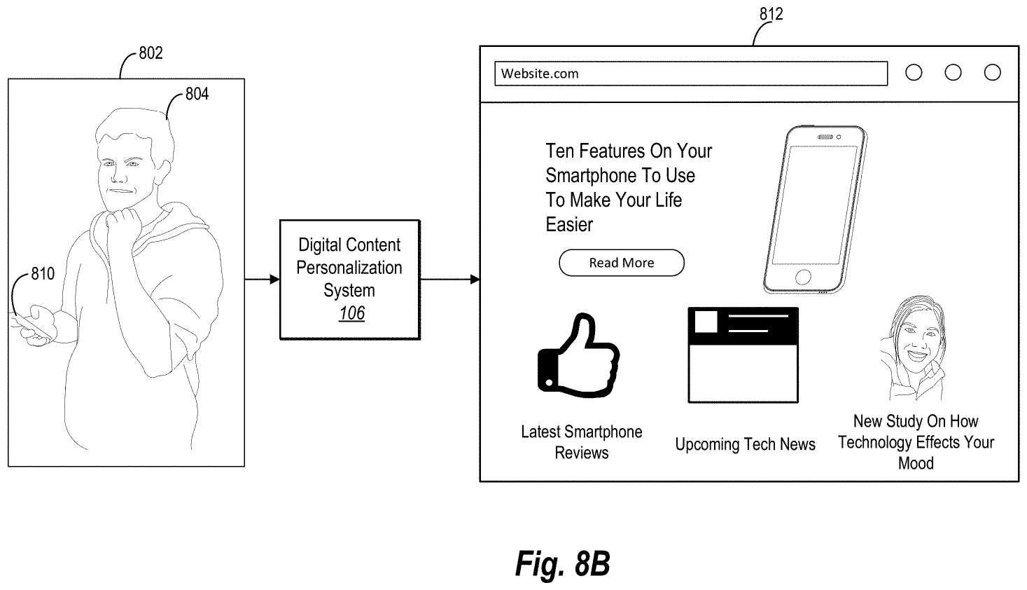

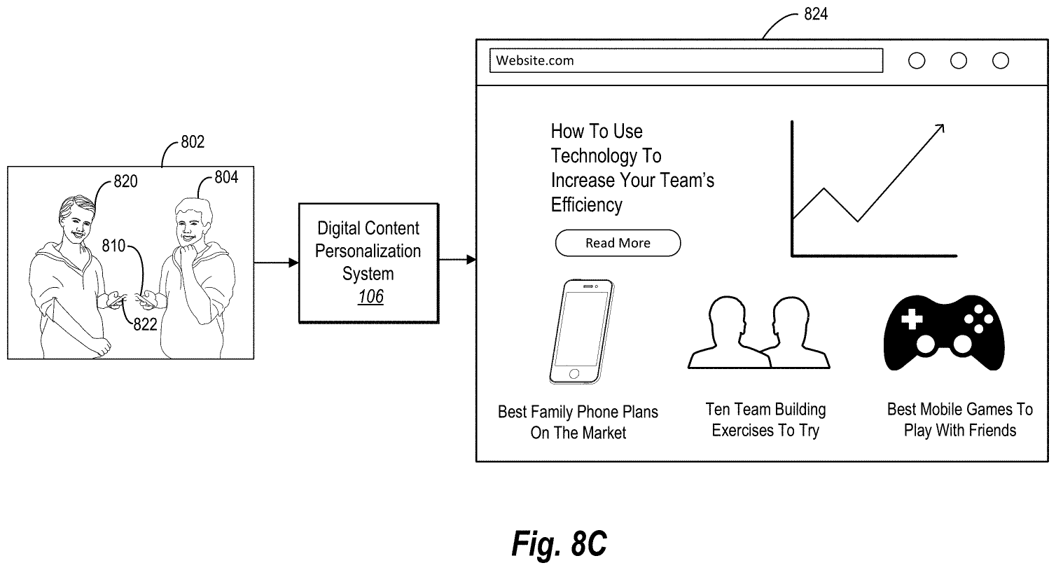

In one or more embodiments, as the digital content personalization system 106 continuously collects a stream of digital media and analyzes the digital media to identify characteristics of a user portrayed in the digital media and/or objects portrayed in the digital media, the digital content personalization system 106 can update the live user context. Accordingly, the digital content personalization system 106 can dynamically generate digital content based on the updated user context and provide the digital content for display via a client device while the user is accessing one or more web sites. FIGS. 8A-8C illustrate block diagrams of the digital content personalization system 106 dynamically changing personalized digital content based on a changing live user context in accordance with one or more embodiments.

As shown in FIG. 8A, the digital content personalization system 106 analyzes the digital video 802 portraying a user 804 while the user 804 accesses one or more websites. As shown in FIG. 8A, the user 804 is holding an object 806 and portraying a positive facial expression. Based on the characteristics and the object identified by analyzing the digital video 802, the digital content personalization system 106 defines a live user context and generates the digital content 808—shown to be displayed in a website (e.g., the one or more websites being accessed by the user 804)—based on the live user context. In particular, in one or more embodiments, the digital content 808 represents digital content presented to the user 804 in response to the user 804 first accessing one or more websites (e.g., in response to sending a request for the website from a remote server). Thus, as used herein, “accessing a website” can include when a client device enters a URL, requests a website corresponding to the URL, displays the website, or navigates within the website (e.g., navigates to different pages).

FIG. 8B illustrates the digital content personalization system 106 analyzing the digital video 802 at a later time. As shown in FIG. 8B, the user 804 is holding the object 810 and portraying a negative facial expression. Accordingly, the digital content personalization system 106 can analyze the digital video 802 to update the live user context and generate the digital content 812 based on the updated user context. In particular, the digital content personalization system 106 can modify the one or more websites that initially displayed the digital content 808 to include the digital content 812 and then provide the modified one or more websites for display via a client device.

FIG. 8C illustrates the digital content personalization system 106 analyzing the digital video 802 at another point in time. As shown in FIG. 8C, the digital video 802 portrays an additional user 820 holding an object 822. Further, the user 804 and the additional user 820 both portray positive facial expressions. Accordingly, the digital content personalization system 106 can analyze the digital video 802 to update the live user context and generate the digital content 824 based on the updated user context. In particular, the digital content personalization system 106 can modify the one or more websites displaying the digital content 812 to include the digital content 824 and then provide the modified one or more websites for display via the client device.

Thus, the digital content personalization system 106 can continuously modify the one or more websites accessed by a user with updated digital content based on a live user context. Accordingly, the digital content personalization system 106 flexibly accommodates changes to the user context. Further, the digital content personalization system 106 provides personalized digital content to a user more accurately than conventional systems as the digital content personalization system 106 selects digital content to provide to the user based on updated user data.

Turning now to FIG. 9, additional detail will now be provided regarding various components and capabilities of the digital content personalization system 106. In particular, FIG. 9 illustrates the digital content personalization system 106 implemented by the computing device 902 (e.g., the server(s) 102 and/or the client device 112a as discussed above with reference to FIG. 1). Additionally, the digital content personalization system 106 is also part of the analytics system 104. As shown, the digital content personalization system 106 can include, but is not limited to, a facial detection model application manager 904, an object detection model application manager 906, an audio detection model application manager 908, a context-based digital content machine learning model application manager 910, a user interface manager 912, a digital characteristics report generator 914, and data storage 916 (which includes a facial detection model 918, an object detection model 920, an audio detection model 922, a context-based digital content machine learning model 924, and digital content 926).

As just mentioned, and as illustrated in FIG. 9, the digital content personalization system 106 includes the facial detection model application manager 904. In particular, the facial detection model application manager 904 utilizes a facial detection model (e.g., the facial detection model 918) to analyze a digital video collected as part of a stream of digital media in order to identify characteristics (i.e., facial characteristics) of the user portrayed in the digital video. As the digital video progresses and the user portrayed in the digital video changes (e.g., changes emotions, facial expressions, etc.), the facial detection model application manager 904 can continuously update the identified characteristics of the user.

As shown in FIG. 9, the digital content personalization system 106 can also include the object detection model application manager 906. In particular, the object detection model application manager 906 utilizes an object detection model (e.g., the object detection model 920) to analyze the digital video collected as part of the stream of digital media in order to identify an object (or objects) portrayed in the digital video. As the digital video progresses and there is a change to the objects portrayed in the video (e.g., more or less objects become visible), the object detection model application manager 906 can continuously update the identified objects.

Additionally, as shown in FIG. 9, the digital content personalization system 106 includes the audio detection model application manager 908. In particular, the audio detection model application manager 908 utilizes an audio detection model (e.g., the audio detection model 922) to analyze audio content collected as part of the stream of digital media in order to identify additional characteristics of the user portrayed in the audio content. As the audio content progresses and the user portrayed in the audio content changes (e.g., changes the words spoken, the tone of voice used, etc.), the audio detection model application manager 908 can continuously update the identified additional characteristics.

Further, as shown in FIG. 9, the digital content personalization system 106 includes the context-based digital content machine learning model application manager 910. In particular, the context-based digital content machine learning model application manager 910 utilizes a context-based digital content machine learning model to select a subset of digital content from a repository of digital content (i.e., digital content 926) based on a live user context—which includes the characteristics identified by the facial detection model application manager 904, the objects identified by the object detection model application manager 906, and/or the additional characteristics identified by the audio detection model application manager 908. As the live user context changes (i.e., as the facial detection model application manager 904 updates the identified characteristics, the object detection model application manager 906 updates the identified objects, and/or the audio detection model application manager 908 updates the identified additional characteristics), the context-based digital content machine learning model application manager 910 can update its selection of digital content.

As shown in FIG. 9, the digital content personalization system 106 further includes the user interface manager 912. In particular, the user interface manager 912 can generate one or more websites that includes the subset of digital content selected by the context-based digital content machine learning model application manager 910. In one or more embodiments, the user interface manager 912 modifies one or more websites currently being presented to the user via a client device to include the subset of digital content. The user interface manager 912 can then provide the one or more websites (e.g., the modified one or more websites) for display via the client device of the user. For example, in some embodiments, the user interface manager 912 presents a website as a default website to a user accessing the website. The user interface manager 912 can then modify the web site to include the subset of digital content and present the modified web site to the user via the client device. In other embodiments, however, the user interface manager 912 does not present a default website to the user. Rather, in response to the user accessing a website, the user interface manager 912 modifies the website to include the subset of digital content and provides the modified website to the user before presenting the original (unmodified) website.

Additionally, as shown in FIG. 9, the digital content personalization system 106 includes the digital characteristics report generator 914. In particular, the digital characteristics report generator 914 can generate a digital characteristics report based on the characteristics of the user identified from the digital video and/or the additional characteristics of the user identified from the audio content. In one or more embodiments, the digital characteristics report generator 914 can generate the digital characteristics report based on the objects identified from the digital video. The digital characteristics report generator 914 can provide the digital characteristics report to the user interface manager 912 for display via a client device.

Further, as shown in FIG. 9, the digital content personalization system 106 includes data storage 916. In particular, data storage 916 includes facial detection model 918, object detection model 920, audio detection model 922, context-based digital content machine learning model 924, and digital content 926. Facial detection model 918 stores the facial detection model utilized by the facial detection model application manager 904 to analyze digital videos and identify characteristics of the user portrayed in the digital videos. Similarly, object detection model 920 stores the object detection model utilized by the object detection model application manager 906 to analyze digital videos and identify objects portrayed in the digital videos. Audio detection model 922 stores the audio detection model utilized by the audio detection model application manager 908 to analyze audio content and identify additional characteristics of the user portrayed in the audio content. Context-based digital content machine learning model 924 stores the context-based digital content machine learning model utilized by the context-based digital content machine learning model application manager 910 to select a subset of digital content based on the live user context associated with the user. Digital content 926 stores the repository of digital content from which the subset of digital content is selected.

Each of the components 904-926 of the digital content personalization system 106 can include software, hardware, or both. For example, the components 904-926 can include one or more instructions stored on a computer-readable storage medium and executable by processors of one or more computing devices, such as a client device or server device. When executed by the one or more processors, the computer-executable instructions of the digital content personalization system 106 can cause the computing device(s) to perform the methods described herein. Alternatively, the components 904-926 can include hardware, such as a special-purpose processing device to perform a certain function or group of functions. Alternatively, the components 904-926 of the digital content personalization system 106 can include a combination of computer-executable instructions and hardware.

Furthermore, the components 904-926 of the digital content personalization system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 904-926 of the digital content personalization system 106 may be implemented as a stand-alone application, such as a desktop or mobile application. Furthermore, the components 904-926 of the digital content personalization system 106 may be implemented as one or more web-based applications hosted on a remote server. Alternatively, or additionally, the components 904-926 of the digital content personalization system 106 may be implemented in a suite of mobile device applications or “apps.” For example, in one or more embodiments, the digital content personalization system 106 can comprise or operate in connection with digital software applications such as ADOBE® ANALYTICS CLOUD® or ADOBE® MARKETING CLOUD®. “ADOBE,” “ANALYTICS CLOUD,” and “MARKETING CLOUD” are either registered trademarks or trademarks of Adobe Inc. in the United States and/or other countries.

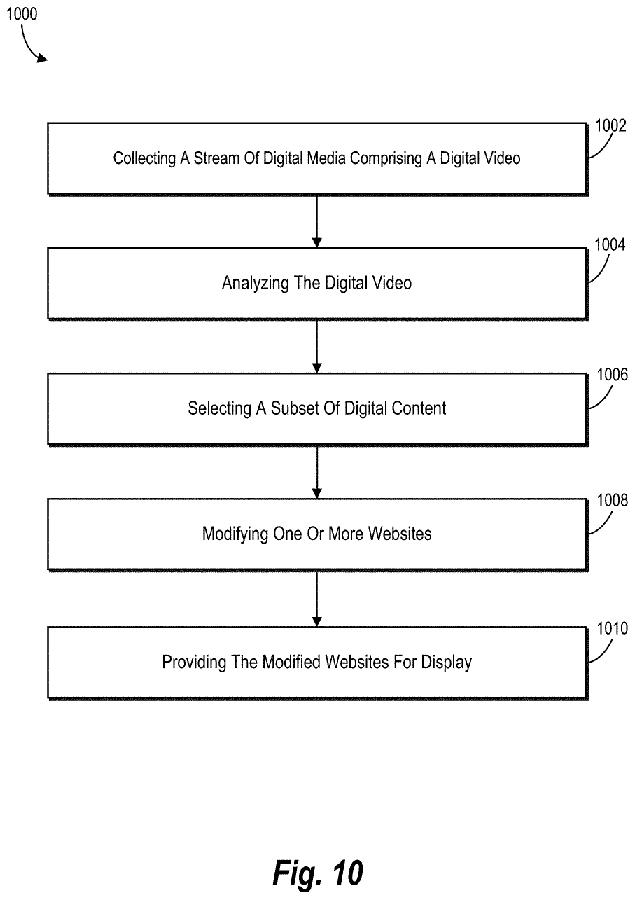

FIGS. 1-9, the corresponding text, and the examples provide a number of different methods, systems, devices, and non-transitory computer readable media of the digital content personalization system 106. In addition to the foregoing, one or more embodiments can also be described in terms of flowcharts comprising acts for accomplishing a particular result, as shown in FIG. 10. FIG. 10 may be performed with more or fewer acts. Further, the acts may be performed in differing orders. Additionally, the acts described herein may be repeated or performed in parallel with one another or in parallel with different instances of the same or similar acts.

As mentioned, FIGS. 10 illustrates a flowchart of a series of acts 1000 for generating personalized digital content based on a current user context in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. For example, in some embodiments, the acts of FIG. 10 can be performed as part of a computer-implemented method for generating personalized digital content in real time in a digital medium environment for collecting live user context data. Alternatively, a non-transitory computer readable medium (i.e., a non-transitory computer readable storage medium) can comprise instructions that, when executed by one or more processors, cause a computing device to perform the acts of FIG. 10. In some embodiments, a system can perform the acts of FIG. 10. For example, in one or more embodiments, a system includes at least one processor and at least one non-transitory computer readable storage medium storing instructions that, when executed by the at least one processor, cause the system to perform the acts of FIG. 10.

The series of acts 1000 includes an act 1002 of collecting a stream of digital media comprising a digital video. For example, the act 1002 involves collecting a stream of digital media comprising a digital video portraying a user while the user accesses one or more websites via a client device. In one or more embodiments, the digital media further comprises audio content providing audio associated with the user while the user accesses the one or more websites.

The series of acts 1000 also includes an act 1004 of analyzing the digital video. For example, the act 1004 involves analyzing the digital video utilizing a facial detection model and an object detection model to identify characteristics of the user portrayed in the digital video. In one or more embodiments, analyzing the digital video to identify the characteristics of the user portrayed in the digital video comprises analyzing the digital video utilizing a facial detection model to identify facial characteristics of the user portrayed in the digital video. In some embodiments, the facial detection model comprises a machine learning model. For example, in some embodiments, the facial detection model comprises an attention controlled neural network trained based on image triplets, characteristic attention projections, and a triplet-loss function. In one or more embodiments, the characteristics of the user comprise at least one of an emotion of the user, a gender of the user, an age of the user, apparel of the user, or a gaze of the user.

In one or more embodiments, the digital content personalization system 106 can analyze the digital video to identify an object portrayed in the digital video. For example, the digital content personalization system 106 can utilize the object detection model to analyze the digital video to identify an object portrayed in the digital video. More specifically, the digital content personalization system 106 can analyze the digital video utilizing an object detection model comprising a neural network classifier to identify an object portrayed in the digital video. In some embodiments, the object portrayed in the digital video comprises at least one of a hand-held object held by the user, a background object, an additional person, clothing, an animal, or a picture of the object. In one or more embodiments, the object detection model comprises a neural network classifier.

The series of acts 1000 further includes an act 1006 of selecting a subset of digital content. For example, the act 1006 involves utilizing a context-based digital content machine learning model to select a subset of digital content from a repository of digital content based on the identified characteristics of the user. Specifically, the act 1006 can include utilizing a context-based digital content machine learning model to select a subset of digital content from a repository of digital content based on the identified facial characteristics of the user. In one or more embodiments, the context-based digital content machine learning model comprises a reinforcement learning model trained to increase a reward in providing digital content in response to the training user contexts. In some embodiments, the context-based digital content machine learning model comprises a neural network trained based on training user contexts and ground truth user results.

In one or more embodiments (e.g., where the digital content personalization system 106 has analyzed the digital video to identify an object portrayed in the video), utilizing the context-based digital content machine learning model to select the subset of digital content from the repository of digital content comprises utilizing the context-based digital content machine learning model to select the subset of digital content from the repository of digital content based on the identified object portrayed in the digital video and the identified characteristics of the user from the digital video portraying the user while the user accesses the one or more websites via the client device. More specifically, in some embodiments, utilizing the context-based digital content machine learning model to select the subset of digital content from the repository of digital content comprises utilizing a context-based digital content machine learning model comprising at least one of a reinforcement learning model or a neural network to select a subset of digital content from a repository of digital content based on the identified facial characteristics of the user and the identified object.

For example, in one or more embodiments, the context-based digital content machine learning model comprises the reinforcement learning model. Accordingly, the digital content personalization system 106 can train the context-based digital content machine learning model by utilizing the context-based digital content machine learning model to generate proposed digital content based on a training user context; identifying a training reward associated with the proposed digital content; and modifying the context-based digital content machine learning model based on the training reward. In some embodiments, the context-based digital content machine learning model comprises the neural network. Accordingly, the digital content personalization system 106 can train the context-based digital content machine learning model by utilizing the context-based digital content machine learning model to generate a predicted user result based on a training user context and training digital content; determining a loss by comparing the predicted user result to a ground truth using a loss function; and modifying parameters of the context-based digital content machine learning model based on the determined loss.

In one or more embodiments (e.g., where the digital media further comprises audio content providing audio associated with the user while the user accesses the one or more websites), the digital content personalization system 106 can utilize an audio detection model to identify additional characteristics of the user from the audio content and utilize the context-based digital content machine learning model to select the subset of digital content from the repository of digital content based on the additional characteristics of the user. For example, in one or more embodiments, the additional characteristics of the user comprise at least one of an emotion of the user or a tone of voice of the user.

In one or more embodiments, the series of acts 1000 further includes acts for generating personalized digital content based on manual input received from the user as well as identified characteristics of a user and/or identified objects from a digital video portraying the user while the user accesses the one or more websites. For example, in one or more embodiments, the acts can include receiving a manual input from the user via the client device while the user accesses the one or more websites; and utilizing the context-based digital content machine learning model to select the subset of digital content from the repository of digital content based on the manual input from the user via the client device while the user accesses the one or more websites and the identified characteristics of the user from the digital video portraying the user while the user accesses the one or more websites via the client device.

Additionally, the series of acts 1000 includes an act 1008 of modifying one or more websites. For example, the act 1008 involves, while the user accesses the one or more websites, modifying the one or more web sites to include the subset of digital content. In one or more embodiments, the digital content personalization system 106 modifies the one or more websites by modifying a title, a header, text, a video, or an image of the one or more websites

Further, the series of acts 1000 includes an act 1010 of providing the modified websites for display. For example, the act 1010 involves, while the user accesses the one or more websites, providing the modified one or more websites for display via the client device.

In one or more embodiments, the series of acts 1000 further includes acts for modifying digital content elements based on where user is looking on the one or more websites. For example, in one or more embodiments, the characteristics of the user comprise the gaze of the user. The digital content personalization system 106 can utilize the facial detection model to identify a digital content element of the one or more websites associated with the gaze of the user (i.e., targeted by the gaze of the user) and, while the user accesses the one or more websites, modify the digital content element. In one or more embodiments, the digital content personalization system 106 can utilize an audio detection model to identify a voice command from the user while the user accesses the one or more websites and, while the user accesses the one or more websites, modify the digital content element based on the voice command.

In some embodiments, the series of acts 1000 further includes acts for generating and providing a digital characteristics report. For example, in one or more embodiments, the acts can include generating a digital characteristics report based on the identified characteristics of the user from the digital video portraying the user while the user accesses the one or more websites via the client device; and while the user accesses the one or more websites, modifying the one or more websites to further include the digital characteristics report based on the identified characteristics of the user from the digital video portraying the user while the user accesses the one or more websites via the client device. More specifically, generating the digital characteristics report can include generating a digital characteristics report based on the identified facial characteristics of the user from the digital video portraying the user while the user accesses the one or more websites via the client device; and, while the user accesses the one or more websites, modify the one or more websites to further include the digital characteristics report based on the identified facial characteristics of the user from the digital video portraying the user while the user accesses the one or more websites via the client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 102, client devices 112a-112n, and the third-party network server 110). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. In a digital medium environment for collecting live user context data, a computer-implemented method for generating personalized digital content in real time, comprising:
performing a step for training a context-based digital content machine learning model to generate digital content in response to training user contexts;
collecting a stream of digital media comprising a digital video portraying a user while the user accesses one or more websites via a client device;
analyzing the digital video to identify characteristics of the user portrayed in the digital video; and
performing a step for utilizing the context-based digital content machine learning model to generate digital content for display while the user accesses the one or more websites via the client device based on the identified characteristics of the user.

2. The method of claim 1, wherein the context-based digital content machine learning model comprises a reinforcement learning model trained to increase a machine learning training reward in providing digital content in response to the training user contexts.

3. The method of claim 1, wherein the context-based digital content machine learning model comprises a neural network trained based on training user contexts and ground truth user results.

4. The method of claim 1, wherein the context-based digital content machine learning model comprises a scene compatibility manager that generates the digital content for display based on a scene compatibility score between a scene portrayed in the digital video and a repository of digital content.

5. A non-transitory computer readable storage medium comprising instructions that, when executed by at least one processor, cause a computing device to:
collect a stream of digital media comprising a digital video portraying a user while the user accesses one or more web sites via a client device; and
generate personalized digital content to provide for display to the user within the one or more websites based on the digital video portraying the user while the user accesses the one or more websites by:
analyzing the digital video utilizing a facial detection model and an object detection model to identify characteristics of the user portrayed in the digital video;
utilizing a context-based digital content machine learning model to select a subset of digital content from a repository of digital content based on the identified characteristics of the user, wherein the context-based digital content machine learning model comprises a neural network trained to increase a machine learning training reward determined from a predict user response to proposed digital content based on training digital content, training user contexts, and ground truth responses; and
while the user accesses the one or more websites:
modifying the one or more web sites to include the subset of digital content; and
providing the modified one or more websites for display via the client device.

6. The non-transitory computer readable storage medium of claim 5, wherein the facial detection model comprises an attention controlled neural network trained based on image triplets, characteristic attention projections, and a triplet-loss function.

7. The non-transitory computer readable storage medium of claim 5, further comprising instructions that, when executed by the at least one processor, cause the computing device to generate the personalized digital content by:
utilizing the object detection model to analyze the digital video to identify an object portrayed in the digital video; and
utilizing the context-based digital content machine learning model to select the subset of digital content from the repository of digital content based on the identified object portrayed in the digital video and the identified characteristics of the user from the digital video portraying the user while the user accesses the one or more websites via the client device.

8. The non-transitory computer readable storage medium of claim 5, further comprising instructions that, when executed by the at least one processor, cause the computing device to train the context-based digital content machine learning model by:
utilizing the context-based digital content machine learning model to generate a predicted user result based on a first training user context and a first training digital content;
determining a loss by comparing the predicted user result to a ground truth using a loss function; and
modifying parameters of the context-based digital content machine learning model based on the determined loss.

9. The non-transitory computer readable storage medium of claim 8, wherein the characteristics of the user comprise a gaze of the user, and further comprising instructions that, when executed by the at least one processor, cause the computing device to generate the personalized digital content by:
utilizing the facial detection model to identify a digital content element of the one or more websites associated with the gaze of the user; and
while the user accesses the one or more websites, modifying the digital content element.

10. The non-transitory computer readable storage medium of claim 9, further comprising instructions that, when executed by the at least one processor, cause the computing device to generate the personalized digital content by:
utilizing an audio detection model to identify a voice command from the user while the user accesses the one or more websites; and
while the user accesses the one or more websites, modifying the digital content element based on the voice command.

11. The non-transitory computer readable storage medium of claim 5,
wherein the stream of digital media further comprises audio content providing audio associated with the user while the user accesses the one or more websites, and
further comprising instructions that, when executed by the at least one processor, cause the computing device to generate the personalized digital content by:
utilizing an audio detection model to identify additional characteristics of the user from the audio content; and
utilizing the context-based digital content machine learning model to select the subset of digital content from the repository of digital content based on the additional characteristics of the user.

12. The non-transitory computer readable storage medium of claim 5, further comprising instructions that, when executed by the at least one processor, cause the computing device to:
generate a digital characteristics report based on the identified characteristics of the user from the digital video portraying the user while the user accesses the one or more websites via the client device; and
while the user accesses the one or more websites, modify the one or more websites to further include the digital characteristics report based on the identified characteristics of the user from the digital video portraying the user while the user accesses the one or more websites via the client device.

13. The non-transitory computer readable storage medium of claim 5, further comprising instructions that, when executed by the at least one processor, cause the computing device to:
receive a manual input from the user via the client device while the user accesses the one or more web sites; and
generate the personalized digital content by utilizing the context-based digital content machine learning model to select the subset of digital content from the repository of digital content based on the manual input from the user via the client device while the user accesses the one or more web sites and the identified characteristics of the user from the digital video portraying the user while the user accesses the one or more websites via the client device.

14. A system comprising:
at least one processor; and
at least one non-transitory computer readable storage medium storing instructions that, when executed by the at least one processor, cause the system to:
collect a stream of digital media comprising a digital video portraying a user while the user accesses one or more websites via a client device; and
generate personalized digital content to provide for display to the user within the one or more websites based on the digital video portraying the user while the user accesses the one or more websites by:
analyzing the digital video utilizing a facial detection model to identify facial characteristics of the user portrayed in the digital video;
analyzing the digital video utilizing an object detection model comprising a neural network classifier to identify an object portrayed in the digital video;
utilizing a context-based digital content machine learning model to select a subset of digital content from a repository of digital content based on the identified facial characteristics of the user and the identified object, wherein the context-based digital content machine learning model comprises a reinforcement learning model trained to select digital content based on machine learning training rewards determined from user responses resulting from providing to provided digital content; and
while the user accesses the one or more websites:
modifying the one or more web sites to include the subset of digital content; and
providing the modified one or more websites for display via the client device.

15. The system of claim 14, further comprising instructions that, when executed by the at least one processor, cause the system to train the context-based digital content machine learning model by:
utilizing the context-based digital content machine learning model to generate proposed digital content based on a training user context;
identifying a machine learning training reward associated with the proposed digital content; and
modifying the context-based digital content machine learning model based on the machine learning training reward.

16. The system of claim 14, wherein the facial characteristics of the user comprise at least one of an emotion of the user, a gender of the user, an age of the user, apparel of the user, or a gaze of the user.

17. The system of claim 14, wherein the object portrayed in the digital video comprises at least one of a hand-held object held by the user, a background object, an additional person, clothing, an animal, or a picture of the object.

18. The system of claim 14,
wherein the stream of digital media further comprises audio content providing audio associated with the user while the user accesses the one or more websites, and
further comprising instructions that, when executed by the at least one processor, cause the system to generate the personalized digital content by utilizing the context-based digital content machine learning model to select the subset of digital content from the repository of digital content based on additional characteristics of the user identified by analyzing the audio content.

19. The system of claim 18, wherein the additional characteristics of the user comprise at least one of an emotion of the user or a tone of voice of the user.

20. The system of claim 14, further comprising instructions that, when executed by the at least one processor, cause the system to:
generate a digital characteristics report based on the identified facial characteristics of the user from the digital video portraying the user while the user accesses the one or more websites via the client device; and
while the user accesses the one or more websites, modify the one or more websites to further include the digital characteristics report based on the identified facial characteristics of the user from the digital video portraying the user while the user accesses the one or more websites via the client device.
